(19) United States
(12) Patent Application Publication
(10) Pub. No.: US 2024/0284538 A1
(43) Pub. Date: Aug. 22, 2024

(54) MANAGING EARLY DATA COMMUNICATION WITH A UE OPERATING IN AN INACTIVE STATE

(71) Applicant: GOOGLE LLC, Mountain View, CA (US)

(72) Inventors: Chih-Hsiang Wu, Taoyuan City (TW); Ching-Jung Hsieh, Taipei City (TW)

(21) Appl. No.: 18/289,759

(22) PCT Filed: May 6, 2022
(86) PCT No.: PCT/US22/27995

§ 371 Date: Nov. 7, 2023

Related U.S. Application Data
(60) Provisional application No. 63/201,684, filed on May 7, 2021.

(51) Int. Cl. H04W 76/20; H04W 76/12; H04W 76/30; H04W 80/02

(52) U.S. Cl. CPC H04W 76/20; H04W 76/12; H04W 76/30; H04W 80/02

(57) ABSTRACT

A central unit control plane (CU-CP), a central unit user plane (CU-UP), and a distributed unit (DU) of distributed base station can implement a method for managing uplink or downlink early data transmission from or to a user equipment (UE) when the UE operates in an inactive state associated with a protocol for controlling radio resources. The method includes: determining the association of logical channel identifier(s) (LCID(s)), radio bearer identifier(s) (RB ID(s)), and tunnel endpoint identifier(s) (TEID(s)) for communicating data between the UE and the CU-UP without transitioning the UE to a connected state associated with the protocol.

### FIELD OF THE DISCLOSURE

This disclosure relates generally to wireless communications and, more particularly, to communication of uplink and/or downlink data at a user equipment (UE) and a radio access network (RAN) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer. The RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures. In some cases, the UE in either the RRC_IDLE or RRC_INACTIVE state has only one, relatively small packet to transmit. In these cases, the UE in either the RRC_IDLE or RRC_INACTIVE state can perform an early data transmission without transitioning to the RRC_CONNECTED state.

However, it is not clear how a distributed base station should manage UE context to support EDT. For example, it is not clear how a distributed base station, a central unit control plane (CU-CP), a central unit user plane (CU-UP), and a distributed unit (DU) should support uplink and downlink EDT for a UE.

### SUMMARY

A DU and/or a CU of a distributed base station implement the techniques of this disclosure to support early data transmission from a UE operating in an inactive or idle state. More specifically, the DU and/or the CU manage the UE context to resume the use of previously established tunnels or establish one or more new tunnels for the UE (e.g., a tunnel for uplink data, a tunnel for downlink data). The DU and/or the CU can identify the tunnels based on tunnel endpoint identifiers (TEIDs).

When the DU receives an uplink data packet, the DU can forward the uplink data packet with the CU-UP or the CU-CP, depending on the implementation or scenario. The DU can identify the context for the UE, when available, based on the logical channel identifier (LCID) and/or a radio bearer identity (RBID) the UE provides to the DU. The context can store one or more TEIDs.

When necessary, the DU and the CU perform a procedure for setting up a new context. When another base station provided the most-recent prior serving cell to the UE, the CU can retrieve the UE context from the other base station. The DU and the CU in this case can utilize respective TEIDs for the CU-DU interface between the DU and CU and for the BS-BS interface between the CU and the other base station. The CU-DU interface can be F1 or W1 interface and the BS-BS interface can be X2 or Xn interface. For example, the DU and the CU can utilize an F1 UL TEID and an Xn UL TEID for uplink data as well as an F1 DL TEID and an Xn DL TEID for downlink data. In some of these cases, the CU can further perform a path transfer procedure.

One example embodiment of these techniques is a method, in a distributed unit (DU) of a distributed base station, for managing an early data transmission (EDT) from a UE. The method includes receiving, by processing hardware, an uplink message from the UE, when a radio connection between the UE and the DU is not active; determining, by the processing hardware, an identifier for communicating data related to the UE between the DU and a central unit (CU) of the distributed base station; and communicating, by the processing hardware to the CU, the data using the identifier.

Another example embodiment of these techniques is a method, in a central unit (CU) of a distributed base station, for managing early data transmission (EDT) from a UE. The method includes receiving, by processing hardware and from a distributed unit (DU) a message from a UE; determining, by the processing hardware based on the message, that the UE is performing EDT; and establishing, by the processing hardware, at least one tunnel for communicating data between the UE and a core network via the DU and the CU.

Still another example embodiment of these techniques is a method, in a central unit (CU) of a distributed base station, for managing a tunnel between the CU and a DU of the base station. The method includes establishing, by processing hardware, the tunnel for communicating data between a UE and a core network via the CU and the DU; determining, by the processing hardware, that a radio connection between the DU and the UE is inactive; in a first instance, in response to determining that EDT for the UE is enabled, retaining the tunnel for EDT communication; and in a second instance, in response to determining that EDT for the UE is disabled, releasing the tunnel.

### BRIEF DESCRIPTION OF THE DRAWINGS

FIG. 1A is a block diagram of an example system in which a base station and/or a user equipment (UE) can implement the techniques of this disclosure for managing early data transmission between the UE and a radio access network (RAN);

FIG. 1B is a block diagram of an example base station including a central unit (CU) and a distributed unit (DU) that can operate in the system of FIG. 1A;

FIG. 2A is a block diagram of an example protocol stack according to which the UE of FIGS. 1A-B can communicate with base stations;

FIG. 2B is a block diagram of an example protocol stack according to which the UE of FIGS. 1A-B can communicate with a DU and a CU of a base station;

FIG. 3A illustrates an example scenario in which a UE initiates early data transmission of an uplink radio resource control message, and a DU communicates with the user plane of a CU (CU-UP) by way of a control plane (CU-CP) for both uplink and downlink data;

FIG. 3B illustrates a scenario similar to that of FIG. 3A, but in which the DU communicates directly with the CU-UP by way of a tunnel;

FIG. 3C illustrates a scenario similar to that of FIG. 3A, but in which the DU receives a plurality of data packet segments and assembles them before transmitting the data packet to the CU;

FIG. 3D illustrates a scenario similar to that of FIG. 3B, but in which the DU receives multiple data packet segments and assembles them before transmitting the data packet to the CU;

FIG. 3E illustrates an example scenario in which a DU transmits one or more uplink data packets to the CU-UP and receives one or more downlink data packets from the CU-UP by way of the CU-CP and after beginning the EDT procedure;

FIG. 3F illustrates a scenario similar to that of FIG. 3E, but in which the DU communicates with the CU-UP directly using one or more tunnels between the DU and the CU-UP;

FIG. 3G illustrates a scenario similar to that of FIG. 3E, but in which the DU receives multiple data packet segments and assembles the segments into a single data packet before transmitting the data packet to the CU;

FIG. 3H illustrates a scenario similar to that of FIG. 3F, but in which the DU receives multiple data packet segments and assembles the segments into a single data packet before transmitting the data packet to the CU;

FIG. 4A illustrates an example scenario in which a CU communicates with a second base station with which the UE has previously communicated, retrieves UE context data from the second base station, and establishes a tunnel with the DU using the UE context data before changing the UE communication path from the second base station to the first base station;

FIG. 4B illustrates a scenario similar to that of FIG. 4A, but in which the request to retrieve the UE context from the second base station fails. and the first BS helps facilitate EDT for the UE and the second base station;

FIG. 5A is a flow diagram of an example method for transmitting uplink data to the CU, establishing a tunnel between the DU and the CU using a logical channel identifier (LCID), receiving downlink data from the CU, and releasing the UE context, implemented in a DU;

FIG. 5B is a flow diagram of an example method similar to FIG. 5A, but in which the first uplink data is transmitted to the CU via the established tunnel, implemented in a DU;

FIG. 5C is a flow diagram of an example method similar to FIG. 5A, but in which the DU only receives an uplink radio resource control message from the UE and only transmits data to the CU via a tunnel, implemented in a DU;

FIG. 5D is a flow diagram of an example method similar to FIG. 5A, but in which the DU and CU communicate data exclusively by way of the CU-CP, implemented in a DU;

FIG. 6A is a flow diagram of an example method for performing security functions on received data, establishing a tunnel between the CU and the DU using an LCID, and transmitting the secure data to the DU via the tunnel, implemented in a CU;

FIG. 6B is a flow diagram of an example method similar to FIG. 6A, but in which the CU receives the first uplink data via the established tunnel, implemented in a CU;

FIG. 6C is a flow diagram of an example method similar to FIG. 6A, but in which the CU does not receive uplink data in the initial DU-to-CU message, implemented in a CU;

FIG. 6D is a flow diagram of an example method similar to FIG. 6A, but in which the CU and DU communicate data exclusively by way of the CU-CP, implemented in a CU;

FIG. 7 is a flow diagram of an example method for receiving DL data and a radio bearer identification (RB ID) from the CU and determining an LCID based on the RB ID;

FIG. 8 is a flow diagram of an example method for performing EDT with a UE via a DU in which the CU transmits DL data and an RB ID to the DU;

FIG. 9A is a flow diagram of an example method for determining whether to communicate data with the CU via a tunnel or by way of a DU-to-CU message to the CU-CP based on whether a tunnel associated with an LCID exists, implemented in a DU;

FIG. 9B is a flow diagram of an example method for determining whether to establish a tunnel between the CU and the DU based on whether a tunnel associated with an LCID exists, implemented in a DU;

FIG. 10 is a flow diagram of an example method for determining whether to retain or release a previously established tunnel based on whether EDT is enabled for the UE, implemented in a CU;

FIG. 11 is a flow diagram of an example method for communicating with a second base station with which the UE has previously communicated, retrieving UE context information for the UE, and establishing a tunnel using a BS-to-BS address indication, implemented in a first BS;

FIG. 12 is a flow diagram of an example method for communicating with a second base station with which the UE has previously communicated, retrieving UE context information for the UE, establishing a tunnel, applying security functions, and transmitting protected downlink data to the UE, implemented in a first base station;

FIG. 13 is a flow diagram of an example method similar to FIG. 12, but in which the UE context data retrieval fails and the first base station communicates data from the UE with the second base station using tunnels, implemented in a first BS;

FIG. 14 is a flow diagram of an example method for processing an EDT, which can be implemented in a DU;

FIG. 15 is a flow diagram of an example method for processing an EDT, which can be implemented in a CU; and

FIG. 16 is a flow diagram of an example method for establishing and retaining or releasing a tunnel, which can be implemented in a CU.

### DETAILED DESCRIPTION OF THE DRAWINGS

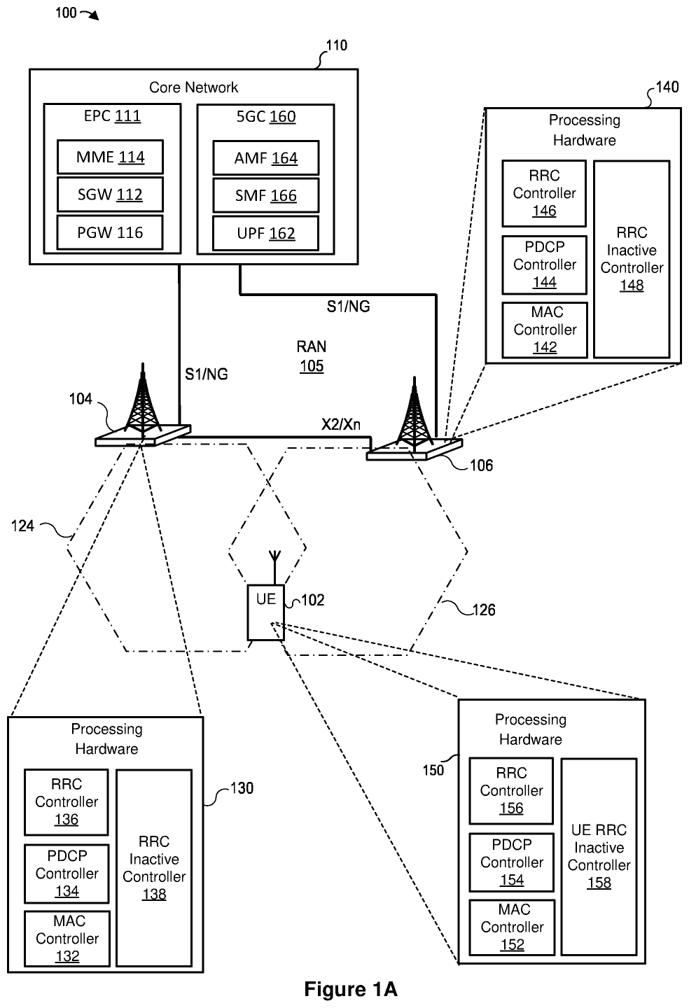

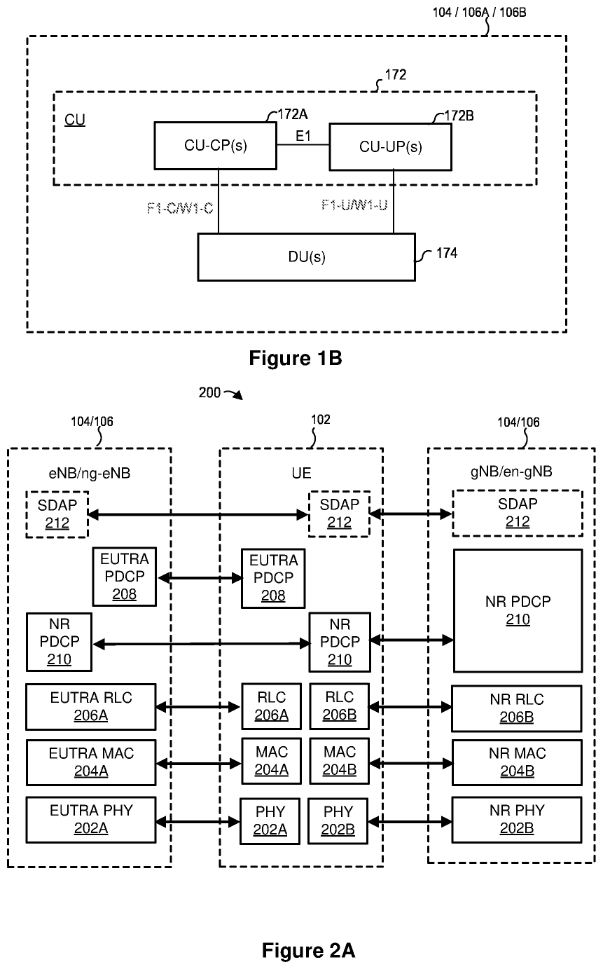

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core, in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 implement the techniques of this disclosure to communicate data when the radio connection between the UE 102 and the RAN 105 is suspended, e.g., in the inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling, control-plane information at a protocol layer of controlling radio resources (e.g., RRC), controlling mobility management (MM), controlling session management (SM), or refers to non-signaling, non-control-plane information at protocol layers above the layer of the protocol for controlling radio resources (e.g., RRC), above the layer of the protocol for controlling MM, above the layer of the protocol for controlling SM, or above the layer of the protocol for controlling quality of service (QOS) flows (e.g., service data adaptation protocol (SDAP)). The data to which the UE and/or the RAN applies the techniques of this disclosure can include, for example, Internet of things (IoT) data, Ethernet traffic data, Internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, selects a cell of the base station 104, and exchanges data with the base station 104—either via the base station 106 or with the base station 104 directly—without transitioning to the RRC_CONNECTED state. In particular, the UE 102 and the base station 104 of the RAN 105 can communicate using early data transmission procedures, without the UE 102 transitioning to the RRC_CONNECTED state.

As a more specific example, the UE 102 in some cases transmits data in the uplink (UL) direction to the RAN 105 while the UE 102 operates in the RRC_INACTIVE or RRC_IDLE state.

After the UE 102 determines that data is available for uplink transmission while the UE 102 operates in the RRC_INACTIVE or RRC_IDLE state, the UE 102 can apply one or more security functions to the UL data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) of the UE 102 in the UL RRC message. The RAN 105 can identify the UE 102 based on the UE ID. In some implementations, the UE ID can be an inactive Radio Network Temporary Identifier (I-RNTI), a resume identity, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 can then transmit the security-protected packet to the RAN 105, while in the RRC_INACTIVE or RRC_IDLE state.

In some implementations, the data is an uplink (UL) service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU, such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In such implementations, the UE 102 may omit a UE ID of the UE 102 from the UL MAC PDU. In yet other implementations, the UE 102 can include the UL PDCP PDU in a UL radio link control (RLC) PDU and then include the UL RLC PDU in the UL MAC PDU. In implementations in which the UL MAC PDU includes the UL RRC message, the UE 102 in some implementations generates an RRC MAC-I and includes the RRC MAC-I in the UL RRC message. For example, the RRC MAC-I may be a resumeMAC-I field, as specified in 3GPP specification 38.331. In other implementations, the UE can obtain the RRC MAC-I from the UL RRC message with an integrity key (e.g., KRRCint key), an integrity protection algorithm, and other parameters COUNT (e.g., 32-bit, 64-bit or 128-bit value), BEARER (e.g., 5-bit value), and DIRECTION (e.g., 1-bit value).

In other implementations, the data is an uplink (UL) service data unit (SDU) of the NAS. The UE 102 applies the security function to the SDU and includes the secured SDU in a first UL PDU such as a NAS PDU, which can be associated with the NAS layer. For example, the NAS layer can be an MM sublayer or an SM sublayer of 5G, Evolved Packet System (EPS), or 6G. Then the UE 102 can include the UL NAS PDU in a second UL PDU, such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may omit an RRC MAC-I from the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 104 can retrieve the UE ID of the UE 102 from the UL RRC message and identify the base station 106 as the destination of the data in the first UL PDU, based on the determined UE ID. In one example implementation, the base station 104 retrieves the first UL PDU from the second UL PDU and transmits the first UL PDU to the base station 106. The base station 106 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 106 derives at least one security key from UE context information of the UE 102. Then the base station 106 retrieves the data from the security-protected packet by using the at least one security key and transmits the data to the CN 110 or edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110 or edge server. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110 or edge server. However, if the base station 106 determines that the MAC-I is invalid, the base station 106 discards the packet.

In another implementation, the base station 104 retrieves the security-protected packet from the first UL PDU. The base station 104 performs a retrieve UE context procedure with the base station 106 to obtain UE context information for the UE 102 from the base station 106. The base station 104 derives at least one security key from the UE context information. Then the base station 104 retrieves the data from the security-protected packet by using the at least one security key and transmits the data to the CN 110 (e.g., UPF 162) or an edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity protected packet may include the data and the MAC-I. The base station 104 can verify whether the MAC-I is valid for the security-protected packet by using the at least one security key (e.g., an integrity key). When the base station 104 confirms that the MAC-I is valid, the base station 106 sends the data to the CN 110. On the other hand, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110. However, if the base station 104 determines that the MAC-I is invalid, the base station 104 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 that is currently operating in the RRC_INACTIVE or RRC_IDLE state, the base station 104 can apply at least one security function to the data to generate a security-protected packet, generate a first DL PDU including the security-protected packet, and include the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting integrity of the data and encrypt the data along with the MAC-I to generate an encrypted packet and an encrypted MAC-I. The base station 104 in some implementations generates a first DL PDU, such as a DL PDCP PDU including the security-protected packet, and then includes the first DL PDU in a second DL PDU associated with the MAC layer, for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, then includes the DL RLC PDU in the DL MAC PDU, and then transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU) including the DL RLC PDU and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI, or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In other implementations, the base station may assign the ID of the UE 102 to the UE 102 in an RRC message (e.g., an RRC release message or an RRC reconfiguration message) that the base station transmits to the UE 102 before transmitting the DCI and scrambled CRC, e.g., while the UE 102 was previously operating in the RRC_CONNECTED state, RRC_INACTIVE state, or RRC_IDLE state.

The UE 102 operating in the RRC_INACTIVE or RRC_IDLE state can receive the DCI and scrambled CRC on the PDCCH. Then the UE 102 confirms that a physical downlink shared channel (PDSCH), including the second DL PDU, is addressed to the UE according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is an integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected—with encrypted data and an encrypted MAC-I—the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) from one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154, configured to transmit DL PDCP PDUs in accordance with which the base station 106 can transmit data in the downlink direction—in some scenarios—and receive UL PDCP PDUs in accordance with which the base station 106 can receive data in the uplink direction—in other scenarios. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or a Service Data Adaptation Protocol (SDAP) of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C or W1-C interface. The CU-UP 172B can be connected to one or more DU 174 through an F1-U or W1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions. A bearer context is a block of information in a CU-UP node associated with one UE that is used for the sake of communication over the E1 interface. It may include the information about data radio bearers, PDU sessions and QoS flows associated with the UE. The block of information contains the necessary information required to maintain user-plane services toward the UE.

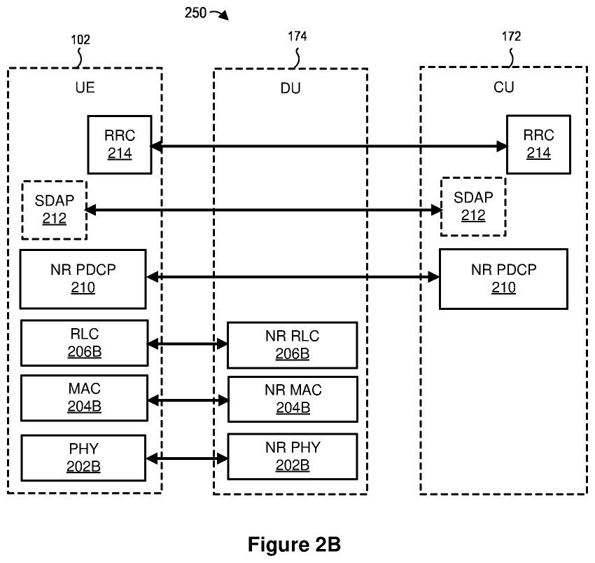

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or an RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUS, Internet Protocol (IP) packets, or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU 172 at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

The General Packet Radio System (GPRS) Tunneling Protocol for transmitting the user plane packets is specified in 3GPP TS 29.281. A GTP-U tunnel is identified in each node with a Tunnel Endpoint Identifier (TEID), an IP address and a UDP port number. The TEID (e.g., 4-octet) unambiguously identifies a tunnel endpoint in the receiving GTP-U protocol entity for a given UDP/IP endpoint. The receiving end side of a GTP tunnel locally assigns the TEID value the transmitting side has to use. The TEID values are exchanged between tunnel endpoints using control plane message. A GTP-U tunnel is necessary to enable forwarding packets between GTP-U entities.

GTP-U Tunnels are used to carry encapsulated T-PDUs and signaling messages between a given pair of GTP-U Tunnel Endpoints. The Tunnel Endpoint ID (TEID) which is present in the GTP header shall indicate which tunnel a particular Transport PDU (T-PDU) belongs to. T-PDU is a user data packet, for example an IP datagram, sent between a UE and a network entity in an external packet data network. A T-PDU is the payload that is tunneled in the GTP-U tunnel. In this manner, packets are multiplexed and de-multiplexed by GTP-U between a given pair of Tunnel Endpoints. The TEID value to be used in the TEID field shall be negotiated for instance during the GTP-C Create PDP Context and the RAB assignment procedures that take place on the control plane. The TEID shall be used by the receiving entity to find the PDP context or bearer context. The TEID in the GTP-U header can be used to de-multiplex traffic incoming from remote tunnel endpoints so that it is delivered to the User plane entities in a way that allows multiplexing of different users, different packet protocols and different QoS levels.

The gNB-DU is responsible for the allocation of the F1-U DL GTP TEID for each data radio bearer. The gNB-CU-UP is responsible for the allocation of the F1-U UL GTP TEID for each data radio bearer. The gNB-CU-UP is responsible for the allocation of the S1-U DL GTP TEID for each E-RAB and the NG-U DL GTP TEID for each PDU Session. The gNB-CU-UP is responsible for the allocation of the X2-U DL/UL GTP TEID or the Xn-U DL/UL GTP TEID for each data radio bearer. For the Xn interface, the user plane packets conveyed by GTP-U may be PDCP PDUs (e.g., in case of dual connectivity), PDCP SDUS (e.g., in case of DRB level data forwarding), or SDAP SDUs (e.g., in PDU Session level data forwarding or QoS flow level data forwarding).

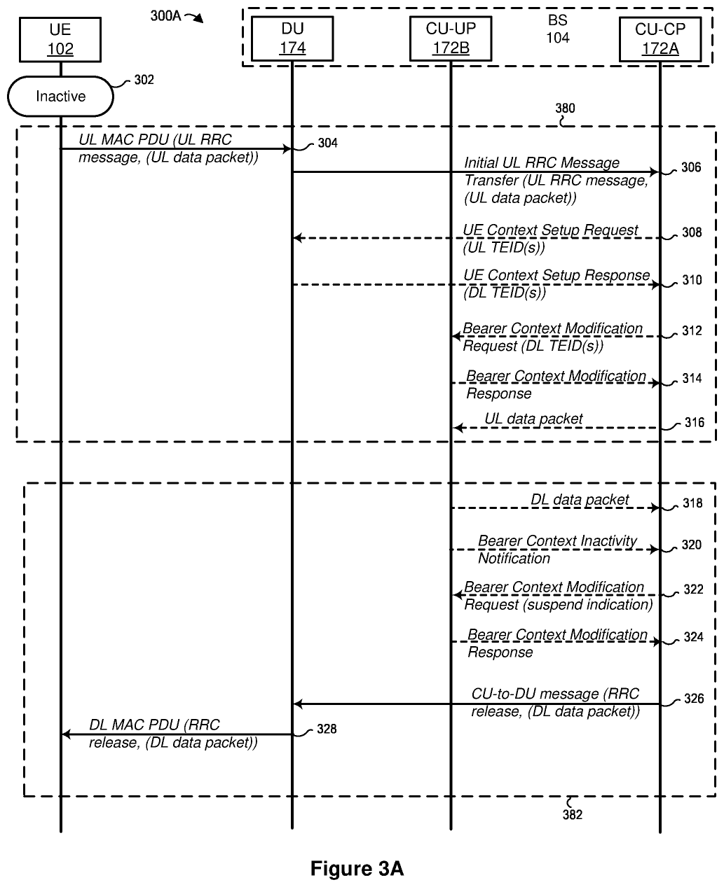

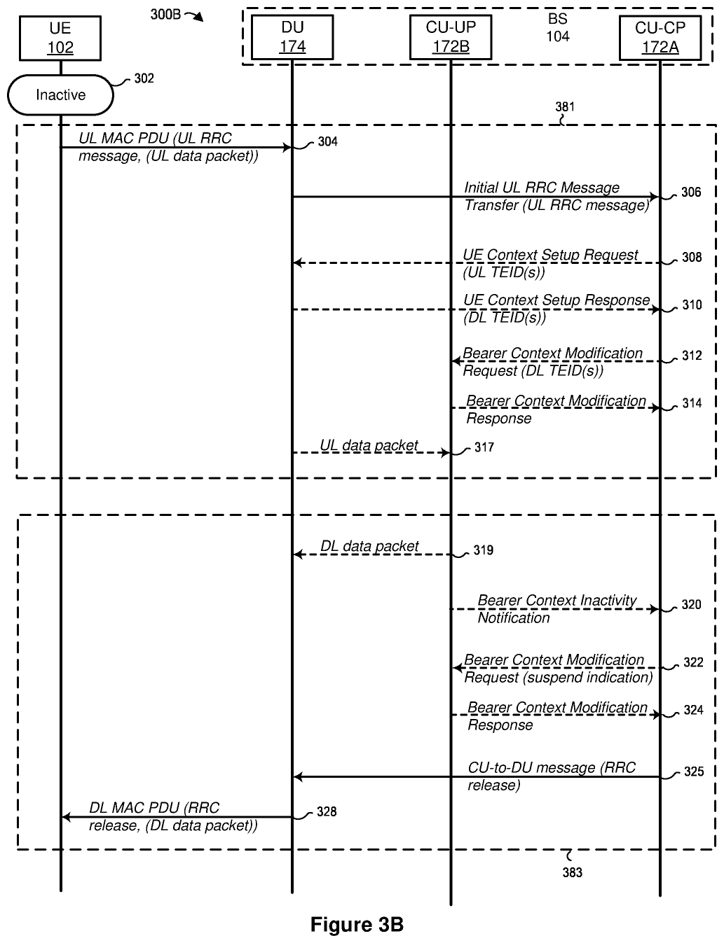

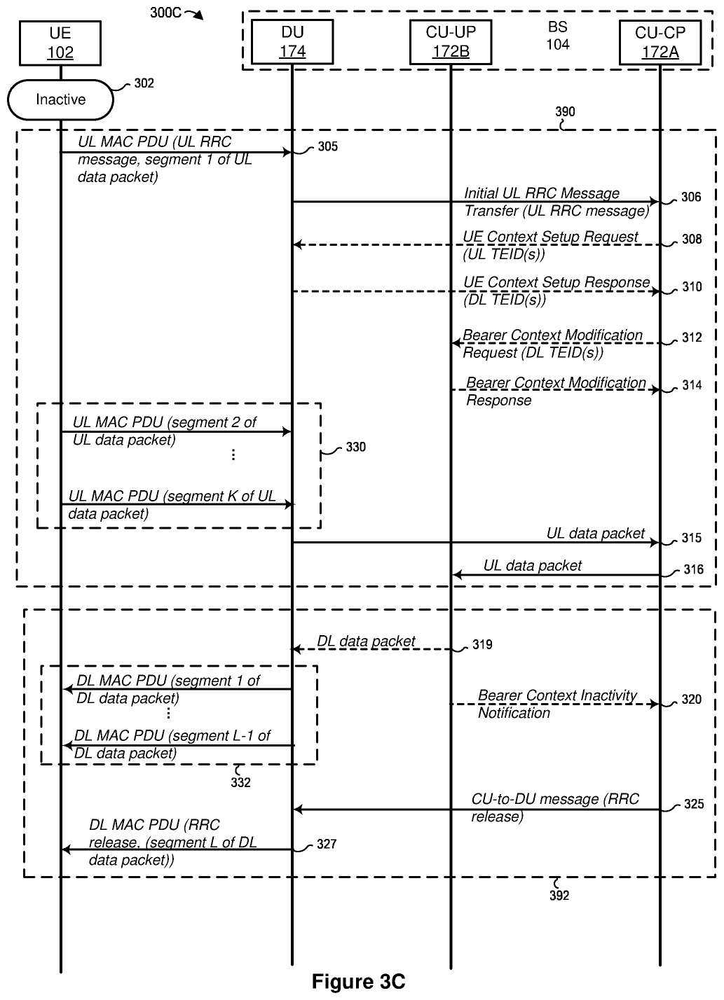

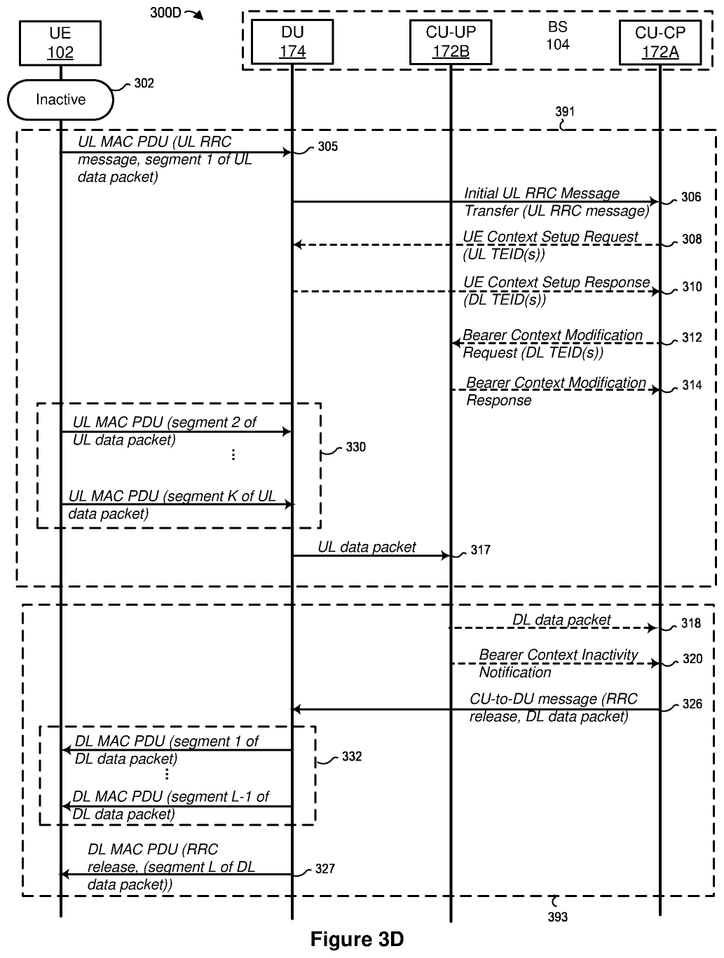

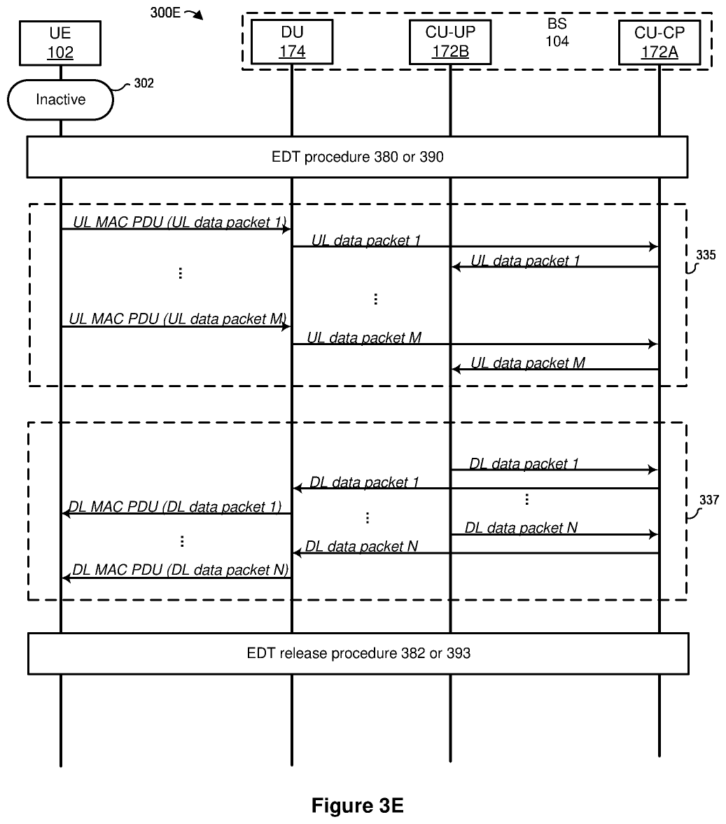

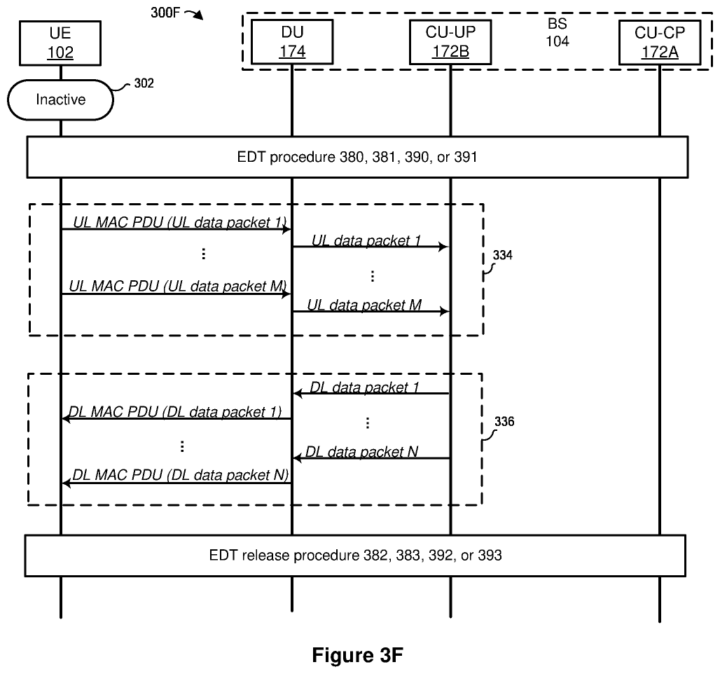

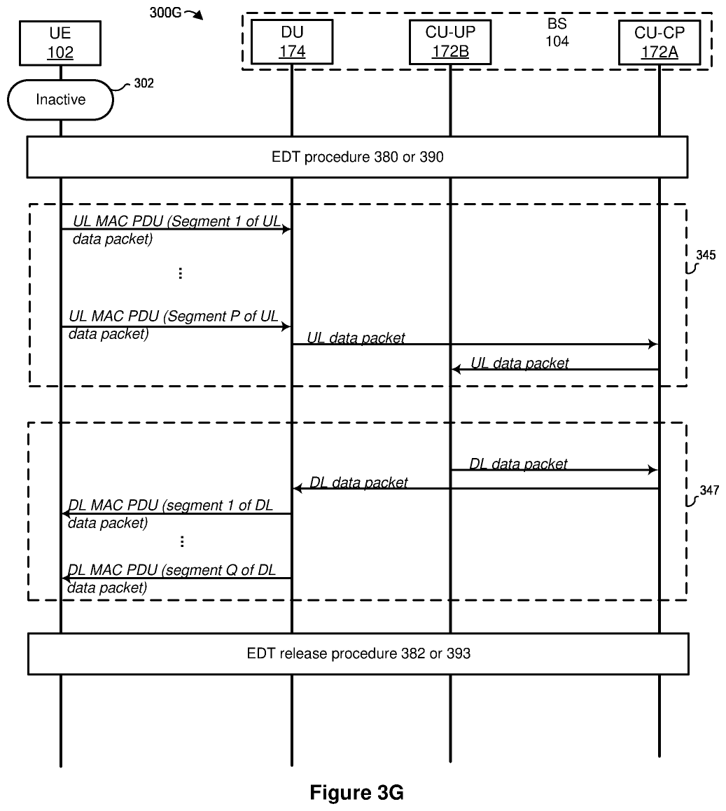

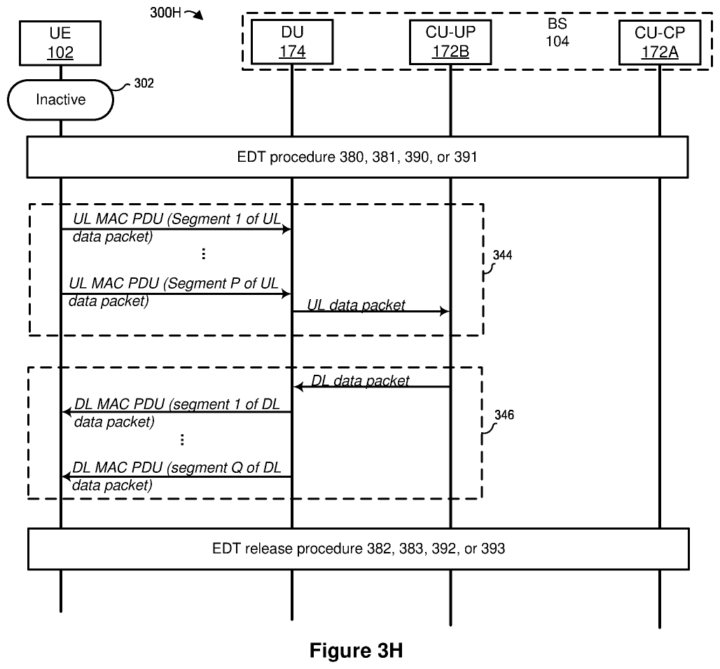

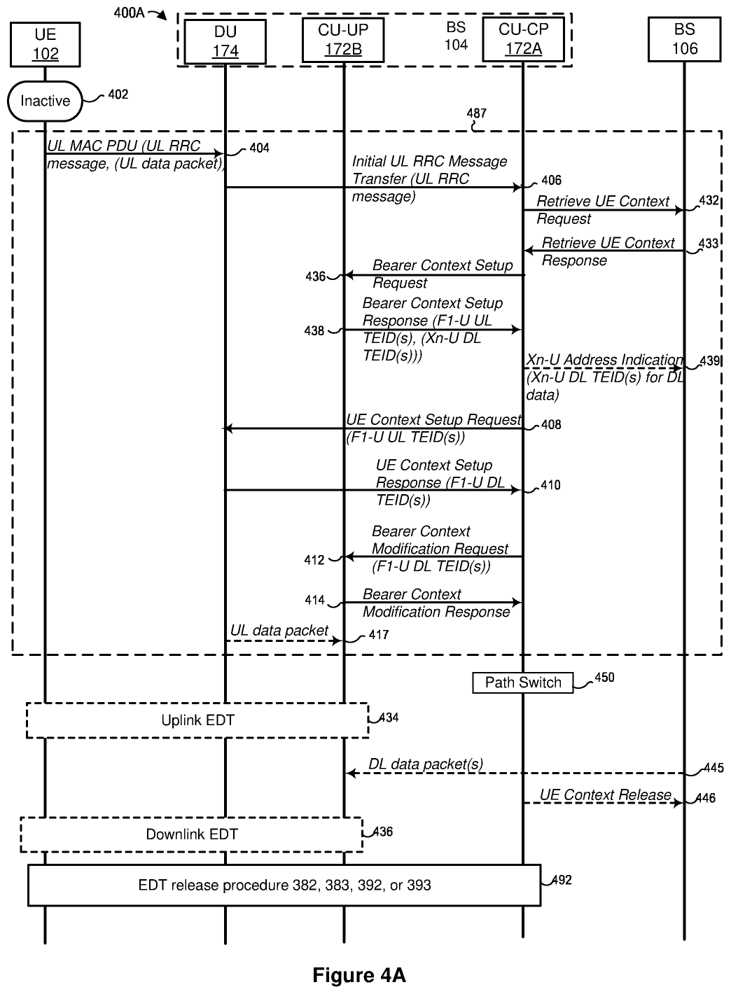

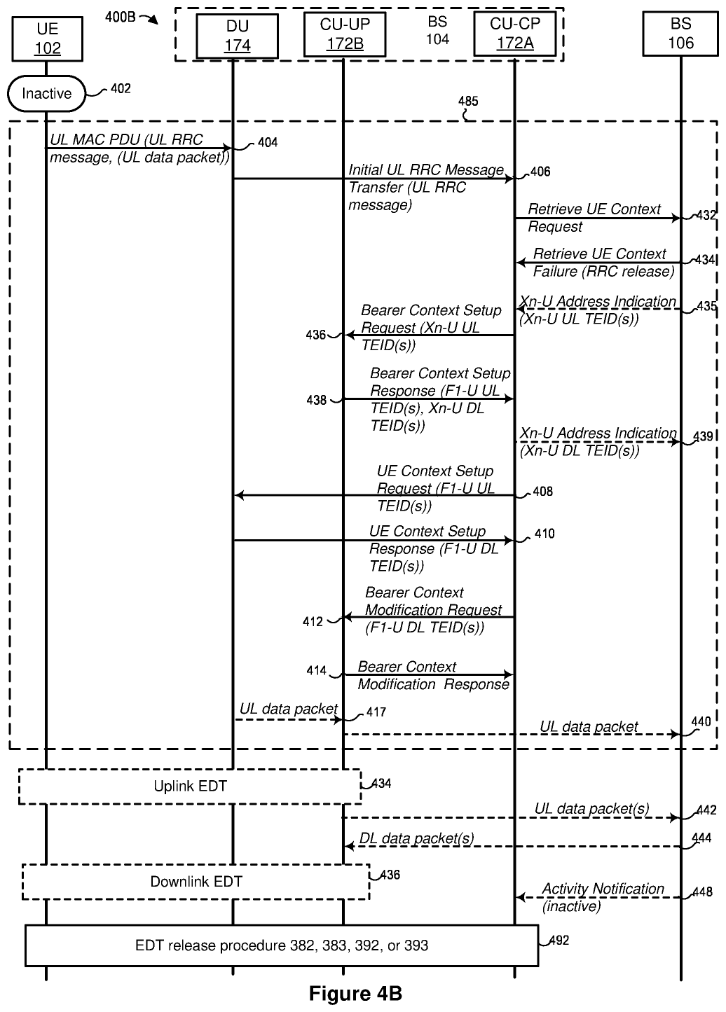

FIGS. 3A-3H and 4A-4B are messaging diagrams of example scenarios in which a UE and nodes of a RAN implement the techniques of this disclosure for uplink and/or downlink early data transmission. Generally speaking, events in FIGS. 3A-3H and 4A-4B that are similar are labeled with similar reference numbers (e.g., event 302 in FIG. 3A is similar to event 302 in FIG. 3B, events 402 in FIGS. 4A-4B), with differences discussed below where appropriate. With the exception of the differences shown in the figures and discussed below, any of the alternative implementations discussed with respect to a particular event (e.g., for messaging and processing) may apply to events labeled with similar reference numbers in other figures.

In some scenarios and implementations and not shown in the figures, the UE 102 previously operated in a connected state with the RAN 105 (e.g., with the base station 104, base station 106, or another base station not shown in FIG. 1A), before transitioning to the inactive state. After a (first) certain period of data inactivity for the UE 102, the RAN 105 can determine that neither the RAN 105 nor the UE 102 has transmitted any data in the downlink direction or the uplink direction, respectively, during the (first) certain period. In response to the determination, the RAN 105 can transmit a first RRC release message (e.g., RRCRelease message or RRCConnectionRelease message) to the UE 102 and instruct the UE 102 to transition to the inactive state. The UE 102 transitions to the inactive state upon receiving the first RRC release message and operates 302 in the inactive state. The RAN 105 can assign UE identity/identifier (ID) (e.g., an I-RNTI or a resume ID) to the UE 102 and include the assigned value in the first RRC release message. After the UE 102 transitions to the inactive state, the UE 102 may perform one or more RAN notification area (RNA) updates with the CU-CP 172A via the DU 174 without state transitions, in some cases. In some implementations, the CU-CP 172A can include a security parameter (e.g., Next Hop Chaining Count) in the first RRC release message. The UE 102 derives security keys (i.e., base key, integrity key(s) and/or encryption key(s)) using the security parameter. For example, the UE 102 derives a base key (e.g., K_{gNB}) using the security parameter and derives integrity key(s) (e.g., KRRCint key and/or the K_{UPint} key) and encryption key(s) (e.g., K_{RRCenc} key and/or K_{UPenc} key) from the base key. The CU-CP 172A derives security keys (i.e., same as the security keys derived by the UE 102) in a similar manner as the UE 102. The CU-CP 172A sends the integrity key (e.g., the K_{UPint} key) and/or encryption key (e.g., the K_{UPenc} key) to the CU-UP 172B. The UE 102 and CU-UP 172B use the integrity key (e.g., the K_{UPint} key) and/or encryption key (e.g., the K_{UPenc} key) in data communication. The UE 102 and CU-CP 172A use the integrity key (e.g., the KRRCint key) and/or encryption key (e.g., the K_{RRCenc} key) in communication of the first RRC release message. In case of CP-UP split, the CU-CP 172A configures UP ciphering and/or integrity protection over the bearer context setup/modification procedure with the CU-UP 172B including the security algorithm and User Plane security keys (the encryption key and/or the integrity protection key). In some implementations, the UP ciphering algorithm may require input parameters including a cipher key KEY (e.g., 128-bit), a COUNT (e.g., 32-bit), a bearer identity BEARER (e.g., 5-bit), a transmission direction DIRECTION (e.g., 1-bit), and the length of the keystream required LENGTH. A keystream can be generated by the ciphering algorithm to encrypt the plaintext to generate the ciphertext and to recover/decrypt the ciphertext to the plaintext.

Referring first to FIG. 3A, in a scenario 300A, the UE 102 initially operates 302 in an inactive state (e.g., RRC_INACTIVE or RRC_IDLE) and the base station (BS) 104 includes a CU-CP 172A, a CU-UP 172B, and a DU 174. The UE 102 previously operated in a connected state with the BS 104 and was sent to the inactive state by the BS 104 as described earlier.

At a later time, while the UE 102 operates 302 in the inactive state, the UE 102 initiates 304 an early data transmission (EDT) to transmit an uplink (UL) MAC PDU to the BS 104 and the BS 104 first receives the UL MAC PDU at the DU 174. The UL MAC PDU may include a UL RRC message and/or a UL data packet. In some implementations, the UL RRC message can be an RRC resume request message (e.g., RRCResumeRequest message, RRCConnectionResumeRequest message, RRCResumeRequest/message, or RRCConnectionResumeRequest/message) including an EDT indicator. The UL data in some example scenarios is an Internet Protocol (IP) packet, an Ethernet packet, or an application packet. In other scenarios, the UL data is a PDU (e.g., RRC PDU, PDCP PDU, RLC PDU, or MAC PDU) that includes an RRC message, a NAS message, an IP packet, an Ethernet packet, or an application packet. Still further, the UL data in some scenarios can be an RRC PDU including a NAS PDU, such that the NAS PDU includes an IP packet, an Ethernet packet, or an application packet. The DU 174 transmits 306 a DU-to-CU message (e.g., Initial UL RRC Message Transfer or UL RRC Message Transfer message) including the UL RRC message and/or the UL data packet and the DU-to-CU message may include an EDT indication and/or a radio bearer identifier (or identity) (RB ID) and/or a logical channel identifier (LCID) associated with the UL data packet. The EDT indication may be an information element (IE), field, or flag of the DU-to-CU message addressed to the CU. The DU 174 may include the UL data packet in a container IE in the DU-to-CU message which may or may not include an associated F1-U (or W1-U) UL TEID(s). In some implementations, the DU 174 can include a first RB ID and/or a LCID associated with the first UL data packet in the DU-to-CU message. The DU 174 may receive a first UL LCID associated with the first UL data packet in the UL MAC PDU and derive the first RB ID from the first UL LCID. The DU 174 may derive the first RB ID based on a predefined one-to-one mapping or a calculation formula. The UE may include a second UL data packet in the UL MAC PDU at event 304. The second UL data packet can be associated with a second RB ID/LCID or the first RB ID/LCID. The CU 172 may use the RB ID to perform security functions on the UL data packet. The first RB ID and the second ID can be DRB IDs.

In some implementations, when the UE 102 is sent to an RRC_IDLE or RRC_INACTIVE state from the RRC_CONNECTED state, the DU 174 may maintain the necessary UE context (e.g., gNB-DU UE F1AP ID, ng-eNB-DU UE W1AP ID, RB ID(s), F1-U UL TEID(s), F1-U DL TEID(s), W1-U UL TEID(s), W1-U DL TEID(s), or RLC, MAC, PHY configuration and parameters such as CellGroupConfig IE) for EDT operations. The DU 174 can determine (or resolve) the associated RB ID(s) and the TEID(s) using the received LCID(s) along with the UL MAC PDU and the maintained UE context. The DU 174 may determine the associated RB ID(s) and the TEID(s) based on a predefined one-to-one mapping of the RB ID, TEID, and LCID or a calculation formula. In such cases, after receiving the DU-to-CU message in event 306, the CU-CP 172A may only perform the Bearer Context Modification procedure (i.e., events 312 and 314) with the CU-UP 172B to indicate resumption of bearer context(s)/resource(s) of the UE 102 while the UE Context Setup procedure (i.e., events 308 and 310) with the DU 174 may be skipped (or replaced with a UE Context Modification procedure if necessary).

In other implementations, the DU 174 does not maintain the necessary UE context for EDT operations so that the CU-CP 172A needs to setup the necessary UE context when there is an EDT uplink or downlink data transmission (e.g., in response to the EDT indication and/or the UL data packet in the DU-to-CU message). In such cases, based on the associated LCID(s)/RB ID(s) received at event 306, the CU-CP 172A transmits 308 a UE Context Setup Request message including the necessary UE context (e.g., the RB ID(s) and CellGroupConfig) and the associated UL TEID(s) for the UL data packet(s) which was allocated by the CU-UP 172B when the UE 102 was in RRC_CONNECTED state. The CellGroupConfig includes RLC-BearerConfig IE(s) each including a particular LCID and an RB ID. Alternatively, the CU-CP 172A can include the LCID(s), associated with the RB ID(s), in a F1AP or W1AP IE in the UE Context Setup Request message. In this case, the CU-CP 172A may or may not include the CellGroupConfig. The DU 174 determines association between a particular LCID and the UL/DL tunnel(s) and allocates an associated DL TEID. The DU 174 transmits 310 a UE Context Setup Response message confirming the setup of the corresponding RB(s) and including the DL TEID(s) for the associated RB(s) (e.g., SRB(s) and/or DRB(s)) in the downlink direction. The CU-CP 172A transmits 312 a Bearer Context Modification Request message including the DL TEID(s) of the associated RB(s) and/or an indication (e.g., Bearer Context Status Change IE) to indicate resumption of bearer context(s)/resource(s) of the UE 102 or EDT operation to the CU-UP 172B. In some implementations, the bearer context(s)/resource(s) can be associated with the RB(s). The CU-UP 172B in response transmits 314 a Bearer Context Modification Response message to the CU-CP 172A. If the CU-CP 172A receives a UL data packet at event 306, the CU-CP 172A transmits 316 the UL data packet to the CU-UP 172B. The CU-CP 172A may transmit 316 a CP-to-UP message including the UL data packet to the CU-UP 172B. The CU-UP 172B may include the UL data packet in a container IE in the CP-to-UP message which may or may not include an associated UL TEID. The events 304, 306, 308, 310, 312, 314, and 316 can be collectively referred to as an EDT procedure 380.

Following the EDT procedure, if the CU-UP 172B receives a DL packet from the core network, the CU-UP 172B may transmit 318 the DL data packet to the CU-CP 172A. In some implementations, the CU-UP 172B can include the DL data packet in a container IE in an UP-to-CP message. In some implementations, the CU-UP 172B may include an associated DL TEID in the UP-to-CP message. The CU-CP 172A may determine an RB ID associated with the DL data packet from the DL TEID. In other implementations, the CU-UP 172B may include an RB ID associated with the DL data packet in the UP-to-CP message. The CU-UP 172B, after a time duration of no incoming DL data, may transmit 320 a Bearer Context Inactivity Notification message to the CU-CP 172A indicating inactive. The CU-CP 172A may transmit 322 a Bearer Context Modification Request message with a suspend indication to the CU-UP 172B. In response, the CU-UP 172B transmits 324 a Bearer Context Modification Response message to the CU-CP 172A. The CU-CP 172A transmits a CU-to-DU message (e.g., DL RRC Message Transfer, UE Context Modification Request, or UE Context Release Command message) to the DU 174 including a second RRC release message (e.g., RRCRelease or RRCConnectionRelease) and/or the DL data packet if received at event 318. The DU 174 transmits 328 a DL MAC PDU including the second RRC release message and/or the DL data packet if received at event 326. In some implementations, the CU-CP 172A can include the RB ID associated with the DL data packet in the CU-to-DU message at event 326. The DU 174 may determine a LCID from the RB ID and includes the LCID in DL MAC PDU including the DL data packet. Thus, the UE 102 can determine the DRB ID from the LCID and use the DRB ID to perform security function (e.g., decryption and/or integrity check) to the DL data packet. The UE 102 may determine the DRB ID based on a predefined one-to-one mapping or a calculation formula. Alternatively, the CU-CP 172A can include the LCID in the CU-to-DU message 326 to indicate the DL data packet associated with the LCID. The events 318, 320, 322, 324, 326, and 328 can be collectively referred to as an EDT release procedure 382.

In some implementations, the CP-to-UP message and the UP-to-CP message can be existing E1 application protocol messages defined in 3GPP specification 38.463. In other implementations, the CP-to-UP message and the UP-to-CP message can be E1 application protocol messages newly defined in 3GPP specification 38.463.

In some implementations, the UE 102 in the inactive state can perform a random access procedure with the DU 174 in response to receiving a paging message or to transmit 304 the UL MAC PDU including the UL RRC message and/or the UL data packet. For example, the random access procedure can be a four-step random access procedure or a two-step random access procedure. In the case of the four-step random access procedure, the UE 102 transmits a random access preamble to the base station 104 and in response, the base station 104 transmits to the UE 102 a random access response (RAR) including an uplink grant, and the UE 102 transmits 304 the UL MAC PDU in accordance with the uplink grant. The DU 174 receives 304 the UL MAC PDU in accordance with the uplink grant in the RAR. The DU 174 can transmit a contention resolution to the EU 102 in response to receiving 304 the UL MAC PDU. In the case of the two-step random access procedure, the UE 102 transmits 304 to the DU 174 a message A including a random access preamble and the UL MAC PDU in accordance with two-step random access configuration parameters. The UE 102 receives the two-step random access configuration parameters in system information broadcast by the DU 174 on cell 124 before transmitting 304 the UL MAC PDU. The DU 174 receives 304 the message A or the UL MAC PDU in accordance with the two-step random access configuration parameters. In other implementations, the UE 102 can transmit 304 the UL MAC PDU on radio resources configured in a PUR configuration or a CG configuration for EDT. The CU-CP 172A can include the PUR or CG configuration for the UE 102 in the first RRC release message. Thus, the base station 104 receives 304 the UL MAC PDU on the radio resources in accordance with the PUR or CG configuration.

Generally speaking, this disclosure refers to an “EDT indication” as an indication that the UE is to initiate, or is requesting to initiate, EDT in order to exchange data with the RAN 105 without transitioning to the connected state. An EDT indication may be formatted in accordance with a suitable protocol, depending on the transmitter of the EDT indication (e.g., a node of the RAN 105 or the UE 102) and the recipient or addressee of the EDT indication. For example, the UE 102 may transmit an EDT indication to the CU-CP 172A and/or the CU-UP 172B via the DU 174 to indicate that the UE 102 is requesting to initiate EDT, where the EDT indication may be formatted in accordance with a protocol having termination points at the UE 102 at the CU-CP 172A and/or the CU-UP 172B.

Now referring to FIG. 3B, a scenario 300B is generally similar to the scenario 300A, except that the data packets do not traverse the CU-CP 172A in the BS 104. The differences between the scenarios of FIG. 3B and FIG. 3A are discussed below.

The DU 174 receives the UL data packet at event 304 and may also receive an LCID associated with the UL data packet in the UL MAC PDU, as discussed with reference to scenario 300A. The DU 174 transmits 306 a DU-to-CU message (e.g., Initial UL RRC Message Transfer or UL RRC Message Transfer message) including the UL RRC message (e.g., RRCResumeRequest or RRCConnectionResumeRequest message) and/or associated LCID(s)/RB ID(s) without passing the UL data packet along.

In some implementations, when the UE 102 transitions to the RRC_IDLE or RRC_INACTIVE state from the RRC_CONNECTED state, the DU 174 may maintain the necessary UE context (e.g., gNB-DU UE F1AP ID, ng-eNB-DU UE W1AP ID, RB ID(s), F1-U UL TEID(s), F1-U DL TEID(s), W1-U UL TEID(s), W1-U DL TEID(s), or RLC, MAC, PHY configuration and parameters such as CellGroupConfig) for EDT operations. The DU 174 can determine (or resolve) the associated RB ID(s) and/or the TEID(s) using the received LCID(s) along with the UL MAC PDU and the maintained UE context. The DU 174 can transmit 317 the UL data packet to the CU-UP 172B using the associated UL TEID and the event 317 may take place before, in parallel, or after the event 306. In such cases, after receiving the DU-to-CU message in event 306, the CU-CP 172A may only perform the Bearer Context Modification procedure (i.e., events 312 and 314) with the CU-UP 172B while the UE Context Setup procedure (i.e., events 308 and 310) with the DU 174 may be skipped (or replaced with a UE Context Modification procedure if necessary).

In other implementations, the DU 174 does not maintain the necessary UE context for EDT operations so that the CU-CP 172A needs to setup the necessary UE context when there is an EDT uplink or downlink data transmission (e.g., in response to the EDT indication and/or the UL data packet in the DU-to-CU message). In such cases, based on the associated LCID(s)/RB ID(s) received at event 306, the CU-CP 172A transmits 308 a UE Context Setup Request message including the necessary UE context (e.g., the RB ID(s) and CellGroupConfig) and the associated UL TEID(s) for the UL data packet(s) which was allocated by the CU-UP 172B when the UE 102 was in an RRC_CONNECTED state. The CellGroupConfig includes RLC-BearerConfig IE(s), each of which includes a particular LCID and an RB ID. Alternatively, the CU-CP 172A can include the LCID(s), associated to the RB ID(s), in a F1AP or W1AP IE in the UE Context Setup Request message. In this case, the CU-CP 172A may or may not include the CellGroupConfig. The DU 174 determines association between a particular LCID and the UL/DL tunnel(s) and allocates associated DL TEID. In some implementations, the DU 174 may receive a first LCID from the UE 102 and use the first LCID to identify an uplink TEID of a tunnel. The DU 174 transmits 310 a UE Context Setup Response message confirming the setup of the corresponding RB(s) and including the DL TEID(s) for the associated RB(s) (e.g., SRB(s) and/or DRB(s)) in the downlink direction.

The CU-CP 172A transmits 312 a Bearer Context Modification Request message including the DL TEID(s) of the associated RB(s) and/or an indication (e.g., Bearer Context Status Change IE) to indicate resumption of bearer context(s)/resource(s) of the UE 102 or EDT operation to the CU-UP 172B. In some implementations, the bearer context(s)/resource(s) can be associated to the RB(s). The CU-UP 172B in response transmits 314 a Bearer Context Modification Response message to the CU-CP 172A. The DU 174 transmits 317 the UL data packet to the CU-UP 172B using the UL TEID obtained in event 308. In other words, the event 317 takes place after events 306 and 308 when the DU 174 did not previously have an UL TEID associated with the UL data packet. In some implementations, the DU 174 generates a GTP-U packet including the UL data packet and the particular TEID and transmits 317 the GTP-U packet to the CU-UP via the tunnel. The events 304, 306, 308, 310, 312, 314, and 317 can be collectively referred to as an EDT procedure 381.

The CU-CP 172A, CU-UP 172B, DU 174 and UE 102 may either perform 382 an EDT release procedure as specified in scenario 300A or the CU-CP 172A may instead perform 383 another EDT release procedure as specified below. The CU-UP 172B optionally transmits 319 a DL data packet to the DU 174. The events 320, 322, 324 are as described in the scenario 300A. The CU-CP 172A transmits 325 a CU-to-DU message (e.g., DL RRC Message Transfer, UE Context Modification Request, or UE Context Release Command message) including the RRC release message (e.g., RRCRelease or RRCConnectionRelease message). The DU 174 transmits 328 a DL MAC PDU including the RRC release message and/or the DL data packet if received from the CU-UP 172B to the UE 102 at event 319. In some implementations, the DU 174 may determine an LCID from the DL TEID associated with the DL data packet and includes the LCID in DL MAC PDU including the DL data packet. Thus, the UE 102 can determine the DRB ID from the LCID and use the DRB ID to perform a security function (e.g., decryption and/or integrity check) with the DL data packet. The UE may make the determination based on a predefined one-to-one mapping or a calculation formula. The events 319, 320, 322, 324, 325, and 328 can be collectively referred to as an EDT release procedure 383.

Now referring to FIG. 3C, a scenario 300C illustrates a scenario which is generally similar to the scenario 300A, except that the data packets are segmented before being transmitted by the UE 102 or the DU 174. The differences between the scenarios of FIG. 3C and FIG. 3A are discussed below.

Assume that, before being transmitted by the UE 102, a UL data packet is segmented by the UE 102 into K segments where K is an integer and greater than 1. K may be less than a predetermined value (e.g., because a UL MAC PDU cannot accommodate the whole UL data packet). The UE 102 transmits 305 a UL MAC PDU including a UL RRC message and the first segment (i.e., segment 1) of a UL data packet. The UE 102 successively transmits the second through Kth segments (i.e., segments 2-K) of the UL data packet in UL MAC PDUs to the DU 174. The transmissions of segments 2 through K may be collectively referred to as event 330. After event 330, the DU 174 combines the segments to obtain the UL data packet and transmits 315 the UL data packet to the CU-CP 172A in a separate DU-to-CU message. The CU-CP 172A in turn transmits 316 the UL data packet to the CU-UP 172B in a CP-to-UP message. The events 305, 306, 308, 310, 312, 314, 315, 316, and 330 can be collectively referred to as an EDT procedure 390.

On the downlink side, the CU-UP 172B optionally transmits 319 a DL data packet to the DU 174. In the example illustration of FIG. 3C, before being transmitted to the UE 102, the DL data packet is segmented by the DU 174 into L segments where L is also an integer and greater than 1, and may be less than a predetermined value. The DU 174 transmits the first L-1 segments of the DL data packet in L-1 DL MAC PDUs and the events can be collectively referred to as event 332. After receiving 325 a CU-to-DU message including an RRC release message from the CU-CP 172A, the DU 174 transmits 327 a DL MAC PDU including the RRC release message and the segment L of the DL data packet to the UE 102. In cases in which the DU 174 segments the DL data packet into L-1 segments, the DU 174 transmits 327 a DL MAC PDU including the RRC release message without including the segment L of the DL data packet. The UE 102 can combine the received segments to reconstruct the DL data packet. In some implementations, the CU-CP 172A can include an RB ID associated with the DL data packet in the CU-to-DU message at event 325. The DU 174 may determine an LCID from the RB ID and include the LCID in the DL MAC PDU including the DL data packet. In other implementations, the DU 174 may determine an LCID from the DL TEID associated with the DL data packet and include the LCID in the DL MAC PDU including the DL data packet. Thus, the UE 102 can determine the RB ID from the LCID and use the RB ID to perform a security function (e.g., decryption and/or integrity check) with the DL data packet. The UE 102 may make the determination based on a predefined one-to-one mapping or a calculation formula between the LCID and the RB ID. In some implementations, the RB ID can be a DRB ID. The events 319, 320, 332, 325, and 327 can be collectively referred to as an EDT release procedure 392.

Referring next to FIG. 3D, a scenario 300D illustrates a scenario which is generally similar to scenario 300B, except that the data packets are segmented before being transmitted by the UE 102 or the DU 174 like scenario 300C. The differences between the scenarios of FIG. 3D and FIGS. 3B and 3C are discussed below.

After receiving 305 a UL MAC PDU including a UL RRC message and a segment 1 of a UL data packet from the UE 102, the DU 174 successively receives the following segments of the UL data packet from UL MAC PDUs in event 330. The DU 174 combines the K segments to obtain the UL data packet and transmits 317 the UL data packet to the CU-UP 172B using the UL TEID obtained at event 308. The events 305, 306, 308, 310, 312, 314, 330, and 317 can be collectively referred to as an EDT procedure 391.

The CU-UP 172B optionally transmits 318 a DL data packet to the CU-CP 172A. In some implementations, the CU-UP 172B can include the DL data packet in a container IE in an UP-to-CP message. In some implementations, the CU-UP 172B may include an associated DL TEID in the UP-to-CP message. The CU-CP 172A may determine an RB ID associated with the DL data packet from the DL TEID. In other implementations, the CU-UP 172B may include an RB ID associated with the DL data packet in the UP-to-CP message. The CU-UP 172B may, after a time duration of no incoming DL data, transmit 320 a Bearer Context Inactivity Notification message to the CU-CP 172A. The CU-CP 172A transmits 326 a CU-to-DU message including an RRC release message and the DL data packet and/or the associated RB ID. The DU 174 segments the DL data packet into L segments and transmits 332 the first L-1 segments in L-1 DL MAC PDUs successively to the UE 102. The DU 174 transmits 327 a DL MAC PDU including the RRC release message and the segment L of the DL data packet to the UE 102. In cases in which the DU 174 segments the DL data packet into L-1 segments, the DU 174 transmits 327 a DL MAC PDU including the RRC release message without including the segment L of the DL data packet. The UE 102 can assemble the received segments to obtain the DL data packet. In some implementations, the DU 174 may determine an LCID from the RB ID associated with the DL data packet and includes the LCID in DL MAC PDU including the DL data packet. Thus, the UE 102 can determine the RB ID from the LCID and use the RB ID to perform a security function (e.g., decryption and/or integrity check) with the DL data packet. The UE 102 may determine the RB ID based on a predefined one-to-one mapping or a calculation formula between the LCID and the RB ID. In some implementations, the RB ID can be a DRB ID.

Referring next to FIG. 3E, a scenario 300E illustrates a scenario which is generally similar to the scenarios 300A and 300C, except that there are follow-up uplink and downlink data packets between the EDT procedure and the EDT release procedure. The differences between the scenarios of FIG. 3E and FIGS. 3A and 3C are discussed below.

The UE 102 initiates the EDT procedure 380 or 390 (as specified in FIGS. 3A and 3C, respectively) with the DU 174, CU-UP 172B, and CU-CP 172A. Following the EDT procedure which associates the LCID(s), RB ID(s), and UL/DL TEID(s) of the data packet(s), the UE 102 continues to transmit M UL MAC PDU(s), where M is an integer and greater than 0. M may be less than a predetermined value. In some implementations, the M UL MAC PDU(s) may include UL data packets to the DU 174. The DU 174 transmits the UL data packets from the received UL MAC PDU(s) to the CU-CP 172A and the CU-CP 172A further transmits the UL data packets to the CU-UP 172B. In some implementations, the DU 174 includes each of the UL data packets in a container IE in a DU-to-CU message and transmits the DU-to-CU message to the CU-CP 172A, which in turn transmits a CP-to-UP message including the UL data packet to the CU-UP 172B. The DU 174 may or may not include the LCID(s), RB ID(s) and/or UL TEID(s) in the DU-to-CU message(s). The CU-CP 172A may or may not include the LCID(s), RB ID(s) and/or UL TEID(s) in the CP-to-UP message(s). The transmission of the M UL data packets from UE 102 to the CU-UP 172B can be collectively referred to as event 335. As for the downlink, the CU-UP 172B transmits N DL data packets to the CU-CP 172A where N is an integer and greater than 0, and may be less than a predetermined value. The CU-CP 172A further transmits the N DL data packets to the DU 174 and DU 174 transmits the N DL data packets in N DL MAC PDUs to the UE 102. In some implementations, the CU-UP 172B includes each of DL data packets in a container IE in an UP-to-CP message and transmits the UP-to-CP message to the CU-CP 172A, which in turn transmits a CU-to-DU message including the DL data packet to the DU 174. The CU-UP 172B may or may not include the LCID(s), RB ID(s) and/or DL TEID(s) in the UP-to-CP message(s). The CU-CP 172A may or may not include the LCID(s), RB ID(s) and/or DL TEID(s) in the CU-to-DU message(s). The transmission of the N DL data packets from the CU-UP 172B to the UE 102 can be collectively referred to as event 337. After the event 337, the CU-CP 172A initiates the EDT release procedure 382 or 393 (as specified in FIGS. 3A and 3D, respectively) with the DU 174, CU-UP 172B, and UE 102.

In some implementations, the DU-to-CU message and the CU-to-DU message can be a UL RRC Message Transfer message and a DL RRC Message Transfer message, respectively. In some implementations, the CP-to-UP message and the UP-to-CP message can be existing E1 application protocol messages defined in 3GPP specification 38.463. In other implementations, the CP-to-UP message and the UP-to-CP message can be E1 application protocol messages newly defined in 3GPP specification 38.463.

Referring next to FIG. 3F, a scenario 300F illustrates a scenario which is generally similar to the scenarios 300B and 300D, except that there are follow-up uplink and downlink data packets between the EDT procedure and the EDT release procedure. The differences between the scenarios of FIG. 3F and FIGS. 3B and 3D are discussed below.

The UE 102 initiates the EDT procedure 380, 381, 390, or 391 (as specified in FIGS. 3A, 3B, 3C, and 3D, respectively) with the DU 174, CU-UP 172B, and CU-CP 172A. Following the EDT procedure which associates the LCID(s), RB ID(s), and UL/DL TEID(s) of the data packet(s), the UE 102 continues to transmit M UL MAC PDU(s) including UL data packets to the DU 174. M is an integer and greater than 0, and may be less than a predetermined value. The DU 174 can determine the UL TEID(s) associated with the UL data packet(s) from the LCID(s) in the UL MAC PDU(s) as described above. The DU 174 transmits the UL data packets from the received UL MAC PDU(s) to the CU-UP 172B using the associated UL TEID(s). The transmission of the M UL data packets from UE 102 to the CU-UP 172B can be collectively referred to as event 334. As for the downlink, the CU-UP 172B transmits N DL data packets associated with the RB(s) or RB ID(s) of the UE 102 to the DU 174 using the DL TEID(s) associated with the RB(s) or RB ID(s) where N is an integer and greater than 0, and may be less than a predetermined value. The DU 174 further transmits the N DL data packets in N DL MAC PDUs to the UE 102. The transmission of the N DL data packets from the CU-UP 172B to the UE 102 can be collectively referred to as event 336. After the event 336, the CU-CP 172A initiates the EDT release procedure 382, 383, 392, or 393 (as specified in FIGS. 3A, 3B, 3C, and 3D, respectively) with the DU 174, CU-UP 172B, and UE 102.

Referring next to FIG. 3G, a scenario 300G illustrates a scenario which is generally similar to the scenario 300E, except that the UE 102 and DU 174 transmit the follow-up uplink and downlink data packets respectively in segments between the EDT procedure and the EDT release procedure. The differences between the scenarios of FIG. 3G and FIG. 3E are discussed below.

The UE 102 initiates the EDT procedure 380 or 390 (as specified in FIGS. 3A and 3C, respectively) with the DU 174, CU-UP 172B, and CU-CP 172A. Following the EDT procedure which associates the LCID(s), RB ID(s), and UL/DL TEID(s) of the data packet(s), the UE 102 continues to transmit P UL MAC PDU(s) including P segments of a UL data packet to the DU 174, similar to event 330, where P is an integer and greater than 0, and may be less than a predetermined value. The DU 174 combines the P segments to obtain the UL data packet and transmits the UL data packet to the CU-CP 172A and the CU-CP 172A further transmits the UL data packet to the CU-UP 172B, similar to event 335. The transmission of the P segments of the UL data packet from the UE 102 to the DU 174 and the UL data packet from the DU 174 to the CU-UP 172B can be collectively referred to as event 345. As for the downlink, the CU-UP 172B transmits a DL data packet to the CU-CP 172A, and the CU-CP 172A further transmits the DL data packet to the DU 174, similar to event 337. The DU 174 segments the DL data packet into Q segments where Q is an integer and greater than 0, and may be less than a predetermined value. The DU 174 then transmits the Q segments in N DL MAC PDUs to the UE 102, similar to event 332. The transmission of the DL data packet from the CU-UP 172B and the Q DL MAC PDUs from the DU 174 to the UE 102 can be collectively referred to as event 347. After the event 347, the CU-CP 172A initiates the EDT release procedure 382 or 393 (as specified in FIGS. 3A and 3D, respectively) with the DU 174, CU-UP 172B, and UE 102.

Referring next to FIG. 3H, a scenario 300H illustrates a scenario which is generally similar to the scenario 300F, except that there are follow-up uplink and downlink data packets that are transmitted in segments between the UE 102 and DU 174 between the EDT procedure 380/381/390/391 and the EDT release procedure 382/383/392/393. The differences between the scenarios of FIG. 3H and FIG. 3F are discussed below.

The UE 102 initiates the EDT procedure 380, 381, 390, or 391 (as specified in FIGS. 3A, 3B, 3C, and 3D, respectively) with the DU 174, CU-UP 172B, and CU-CP 172A. Following the EDT procedure which associates the LCID(s), RB ID(s), and UL/DL TEID(s) of the data packet(s), the UE 102 continues to transmit P UL MAC PDU(s) including the segments of a UL data packet to the DU 174, similar to event 330, where P is an integer and greater than 1, and may be less than a predetermined value. The DU 174 assembles the P segments to obtain the UL data packet and transmits the UL data packet to the CU-UP 172B using the associated UL TEID, similar to event 317. The transmission of the P UL MAC PDUs from UE 102 to the DU 174 and the UL data packet from the DU 174 to the CU-UP 172B can be collectively referred to as event 344. As for the downlink, the CU-UP 172B transmits a DL data packet to the DU 174 using the associated DL TEID, similar to event 319. The DU 174 segments the DL data packet into Q segments and further transmits them in Q DL MAC PDUs to the UE 102, similar to event 332, where Q is an integer and greater than 1, and may be less than a predetermined value. The transmission of the DL data packet from the CU-UP 172B to the DU 174 and the L DL MAC PDUs from the DU 174 to the UE 102 can be collectively referred to as event 346. After the event 346, the CU-CP 172A initiates the EDT release procedure 382, 383, 392, or 393 (as specified in FIGS. 3A, 3B, 3C, and 3D, respectively) with the DU 174, CU-UP 172B, and UE 102.

Referring now to FIG. 4A, a scenario 400A involving a UE initiating an EDT procedure and accessing a BS (e.g., BS 104) different from a last or most-recent prior serving BS (e.g., BS 106) which operated with the UE 102 in a connected state and sent the UE to an inactive state is depicted. The BS 104 retrieves the complete UE context of the UE 102 from the BS 106 and becomes the serving BS. In some implementations, the complete UE context can be UE Context Information defined in 3GPP specification 38.423 or 36.423.

While the UE 102 operates 402 in the inactive state, the UE 102 may move away from its original position and access the BS 104 via the DU 174. The UE 102 transmits 404 to the DU 174 via cell 124 a UL MAC PDU including a UL RRC message and a UL data packet and/or a first LCID associated with the UL data packet. In some implementations, the UE 102 may also include other UL data packet(s) and/or LCID(s) associated with the other UL data packet(s) in the UL MAC PDU. The LCID(s) can include the first LCID and/or other LCID(s). The DU 174 transmits 406 a DU-to-CU message (e.g., Initial UL RRC Message Transfer or UL RRC Message Transfer message) including the UL RRC message and/or the associated LCID(s) to the CU-CP 172A. The UL RRC message includes a UE inactive identifier (e.g., I-RNTI) and/or a MAC-I (e.g., resumeMAC-I or ResumeMAC-I) so that the CU-CP 172A can resolve the most-recent prior serving BS contained in the UE inactive identifier and find that the most-recent prior serving BS is the BS 106. In some implementations, the DU-to-CU message may further include the LCID(s).

The CU-CP 172A transmits 432 a Retrieve UE Context Request message containing the MAC-I, the UE inactive identifier, a cell identity of cell 124, and/or a C-RNTI to the BS 106 (or the CU(-CP) of the BS 106 if it has a distributed architecture). The BS 106 identifies the complete UE context of the UE 102 from the UE inactive identifier and verifies whether the MAC-I is valid by the security information in the complete UE context. In cases that the MAC-I is valid, the BS 106 determines to provide the complete UE context to the BS 104. In response to the determination, the BS 106 transmits 433, to CU-CP 172A, a Retrieve UE Context Response message including the complete UE context for the UE 102. The complete UE context can include UE context (e.g., RB ID(s) and CellGroupConfig) as described for FIG. 3A-H. The CU-CP 172A transmits 436 a Bearer Context Setup Request message to the CU-UP 172B. The CU-UP 172B in response transmits 438 a Bearer Context Setup Response message including F1-U (or W1-U) UL TEID(s) and/or Xn-U (or X2-U) DL TEID(s) and the transport layer address to the CU-CP 172A. The CU-CP 172A may, after obtaining the Xn-U (or X2-U) DL TEID(s), transmit 439 an Xn-U (or X2-U) Address Indication message to the BS 106 to provide the Xn-U (or X2-U) DL TEID(s) for remaining DL data packets if any. The CU-CP 172A transmits 408 a UE Context Setup Request message to the DU 174 including the F1-U (or W1-U) UL TEID(s) and the UE context, similar to event 308. The DU 174 in response transmits 410 a UE Context Setup Response including F1-U (or W1-U) DL TEID(s) to the CU-CP 172A, similar to event 310. The CU-CP 172A transmits 412 a Bearer Context Modification Request to inform the CU-UP 172B of the F1-U (or W1-U) DL TEID(s) and the CU-UP 172B transmits 414 a Bearer Context Modification Response back to the CU-CP 172A, similar to events 312 and 314 respectively.

The DU 174, based on the LCID of the UL data packet and the UE context, determines the association of the LCID, RB ID, and/or UL TEID as described for FIG. 3B and transmits 417 the UL data packet to the CU-UP 172B using the UL TEID. The CU-UP 172B can determine the RB ID associated with the UL data packet from the UL TEID and perform a security function (e.g., decryption and/or integrity check) with the UL data packet using the RB ID. The events 404, 406, 432, 433, 436, 438, 439, 408, 410, 412, 414, 417 can be collectively referred to as an EDT procedure involving successful UE context retrieval 487. After event 487, the UE 102 can perform 434 an uplink EDT procedure with the DU 174 and the CU-UP 172B, similar to event 334 or event 344 depending on whether packet segmentation is used. The CU-UP 172B can determine the RB ID(s) associated with the UL data packet(s) 434 from the UL TEID(s) and perform a security function (e.g., decryption and/or integrity check) with the UL data packet(s) using the RB ID(s). After the event 487, the CU-CP 172A can perform 450 a path switch procedure with the core network (CN) 110 (e.g., the AMF 164 or MME 114).

If there is a remaining DL data packet left at the BS 106, the BS 106 may transmit 445 a DL data packet to the CU-UP 172B using the associated Xn-U (or X2-U) DL TEID. The CU-UP 172B then performs a security function (e.g., encryption and/or integrity protection) with the DL data packet using an RB ID associated to the DL data packet and forwards the DL data packet (i.e., the security-protected DL data packet) to the DU 174 using the associated F1-U DL TEID, and the DU 174 transmits the DL data packet to the UE 102 in downlink EDT procedure 436, similar to event 336 or 346 depending on whether packet segmentation is used. As described for FIG. 3A-3H, the UE 102 can determine the associated RB ID from the associated LCID and use the RB ID to perform a security function (e.g., decryption and/or integrity check) with the DL data packet. The UE 102 may make the determination based on a predefined one-to-one mapping or a calculation formula. The uplink EDT and downlink EDT procedures can be in parallel or one after another. In some implementations, the CU-CP 172A transmits 446 a UE context release message to the second BS 106 completing the path switch 450. The CU-CP 172A later initiates an EDT release procedure 382, 383, 392, or 393 (as specified in FIGS. 3A, 3B, 3C, and 3D, respectively) with the DU 174, CU-UP 172B, and UE 102. The EDT release procedure may be generically known as event 492.

In some implementations, the UL data packet may correspond to multiple UL data packet segments. In such implementations, the UE 102 may transmit 404 the first UL data packet segment with the uplink RRC message, similar to events 305, 330. The UE 102 may then transmit the remaining UL data packet segments to the DU 174 in one or more uplink messages. Similarly, the DL data packet may correspond to multiple DL data packet segments, and the DU 174 may transmit the DL data packet segments to the UE 102 in a similar manner.

Referring next to FIG. 4B, a scenario 400B is depicted which is similar to 400A and similarly involves a UE 102 accessing a BS (e.g., BS 104) different from the most-recent prior serving BS (e.g., BS 106) when it initiates an EDT procedure. However, unlike scenario 400A, the BS 104 may retrieve only a subset of the complete UE context from the BS 106 and the BS 106 retains its connection with the core network and holds the complete UE context.

While the UE 102 operates 402 in the inactive state, the UE 102 may move away from its original position and access the BS 104 via the DU 174. The UE 102 transmits 404 to the DU 174 via cell 124 a UL MAC PDU including a UL RRC message, a UL data packet, and/or a first LCID associated with the UL data packet. The DU 174 transmits 406 a DU-to-CU message (e.g., Initial UL RRC Message Transfer or UL RRC Message Transfer message) including the UL RRC message to the CU-CP 172A. The UL RRC message includes a UE inactive identifier (e.g., I-RNTI) and/or a MAC-I (e.g., resumeMAC-I or ResumeMAC-I) so that the CU-CP 172A can resolve the most-recent prior serving BS contained in the UE inactive identifier and find that the most-recent prior serving BS is the BS 106. The CU-CP 172A transmits 432 a Retrieve UE Context Request message containing the MAC-I, the UE inactive identifier, a cell identity of cell 124, and/or a C-RNTI to the BS 106 (or the CU(-CP) of the BS 106 for implementations in a distributed architecture). The BS 106 verifies whether the MAC-I is valid using the security information in the complete UE context. In cases in which the MAC-I is valid, the BS 106 determines not to provide the complete UE context to the BS 104. As such, the BS 106 keeps the UE 102 in an inactive state.

In response to the determination, the BS 106 transmits 434, to the CU-CP 172A, a Retrieve UE Context Failure message (or a new defined XnAP (or X2AP) message for EDT context retrieval) including an RRC release message and/or a subset of the UE context (e.g., HandoverPreparationInformation or a new defined RRC container/inter-node RRC message with only necessary UE context and configurations related to EDT operations) for the UE 102. In one implementation, the subset of the UE context may include the RB ID(s) and CellGroupConfig which includes RLC-BearerConfig IE(s), each including a particular LCID and an RB ID for the RB allowed to perform EDT. In another implementation, the subset of the UE context may include the RB ID(s) and CellGroupConfig, which includes RLC-BearerConfig IE(s), each including a particular LCID and an RB ID for the RB allowed or not allowed to perform EDT. In some implementations, the subset of the UE context may be provided in a separate XnAP message different from the Retrieve UE Context Failure message carrying the RRC release message. The BS 106 may transmit 435 an Xn-U (or X2-U) Address Indication including Xn-U (or X2-U) UL TEID(s) to the CU-CP 172A. The CU-CP 172A, after receiving the subset of UE context, transmits 436 a Bearer Context Setup Request message to the CU-UP 172B which may include the Xn-U (or X2-U) UL TEID(s) and the subset of UE context. In response, the CU-UP 172B transmits 438 a Bearer Context Setup Response message including F1-U (or W1-U) UL TEID(s) and/or Xn-U (or X2-U) DL TEID(s) to the CU-CP 172A. The CU-CP 172A may, after obtaining the Xn-U (X2-U) DL TEID(s), transmit 439 an Xn-U (or X2-U) Address Indication message to the BS 106 to provide the Xn-U (or X2-U) DL TEID(s) for remaining DL data packets, if any.

The CU-CP 172A transmits 408 a UE Context Setup Request message to the DU 174, including the F1-U (or W1-U) UL TEID(s) and the subset of UE context, similar to event 308. The DU 174, in response, transmits 410 a UE Context Setup Response, including F1-U (or W1-U) DL TEID(s) to the CU-CP 172A, similar to event 310. The CU-CP 172A transmits 412 a Bearer Context Modification Request to inform the CU-UP 172B of the F1-U (or W1-U) DL TEID(s), and the CU-UP 172B transmits 414 a Bearer Context Modification Response back to the CU-CP 172A, similar to events 312 and 314 respectively. The DU 174, based on the LCID of the UL data packet and the UE context, determines the association of the LCID, RB ID, and/or UL TEID as described for FIG. 3B and transmits 417 the UL data packet to the CU-UP 172B using the associated UL TEID. The CU-UP 172B forwards 440 the UL data packet to the BS 106 using the associated Xn-U (X2-U) UL TEID. The BS 106 can determine the RB ID where the UL data packet 400 is associated from the associated Xn-U (X2-U) UL TEID and perform a security function (e.g., decryption and/or integrity check) with the UL data packet using the RB ID. The events 404, 406, 432, 434, 435, 436, 438, 439, 408, 410, 412, 414, 417, and 440 can be collectively referred to as an EDT procedure involving unsuccessful UE context retrieval 485.

After performing 434 an UL EDT procedure as described with reference to FIGS. 3A-3H above, the CU-UP 172B may transmit 442 UL data packet(s) to the second BS 106 using the associated Xn-U (X2-U) UL TEID(s). The BS 106 can determine the RB ID(s) where the UL data packet 400 is associated from the associated Xn-U (X2-U) UL TEID(s) and perform a security function (e.g., decryption and/or integrity check) with the UL data packet(s) 442 using the RB ID(s). If a DL data packet exists at the BS 106 after event 485, the BS 106 may perform a security function (e.g., encryption and/or integrity protection) with the DL data packet 442 using an RB ID associated to the DL data packet. Then the BS 106 transmits 444 the DL data packet (i.e., the security-protected DL data packet) to the CU-UP 172B using the associated Xn-U (or X2-U) DL TEID. The CU-UP 172B may forward the DL data packet to the DU 174 using the associated F1-U (or W1-U) DL TEID, and the DU 174 may transmit the DL data packet to the UE 102 in a DL MAC PDU without accompanying an RRC message as part of a downlink EDT procedure 436. The uplink EDT and downlink EDT procedures can be in parallel or one after another. The BS 106 may transmit 448 an Activity Notification message, indicating UE inactivity to the CU-CP 172A, and the CU-CP 172A indicates a suspension to the CU-UP 172B using a Bearer Context Modification Request. The CU-CP 172A later transmits a CU-to-DU message including the RRC release message received to the DU 174. The DU 174 transmits, to the UE 102, a DL MAC PDU including the RRC release message and/or the DL data packet received. In some implementations, the DU 174 may determine an LCID from the DL TEID associated with the DL data packet and include the LCID in DL MAC PDU including the DL data packet. Thus, the UE 102 can determine the RB ID from the LCID and use the RB ID to perform a security function (e.g., decryption and/or integrity check) with the DL data packet. The UE 102 may make the determination based on a predefined one-to-one mapping or a calculation formula.

In some implementations, the UL data packet may correspond to multiple UL data packet segments. In such implementations, the UE 102 may transmit 404 the first UL data packet segment with the uplink RRC message, similar to events 305, 330. The UE 102 may then transmit the remaining UL data packet segments to the DU 174 in one or more uplink messages. Similarly, the DL data packet may correspond to multiple DL data packet segments, and the DU 174 may transmit the DL data packet segments to the UE 102 in a similar manner.

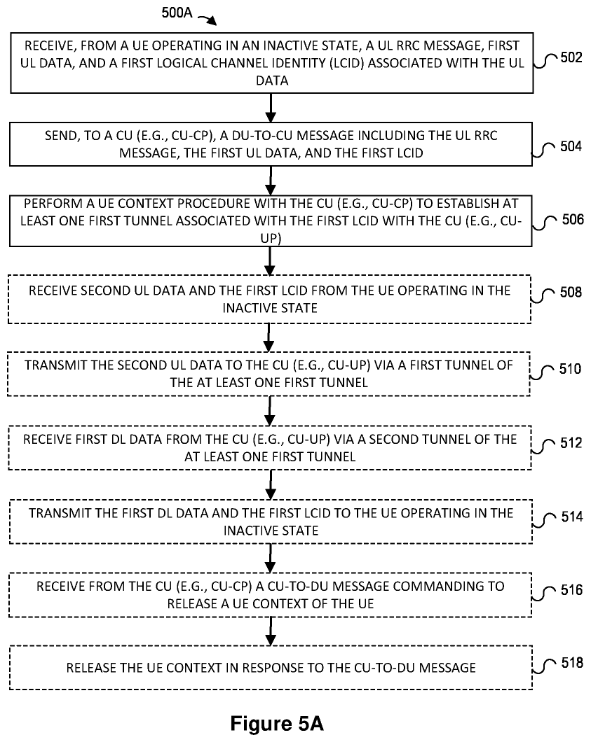

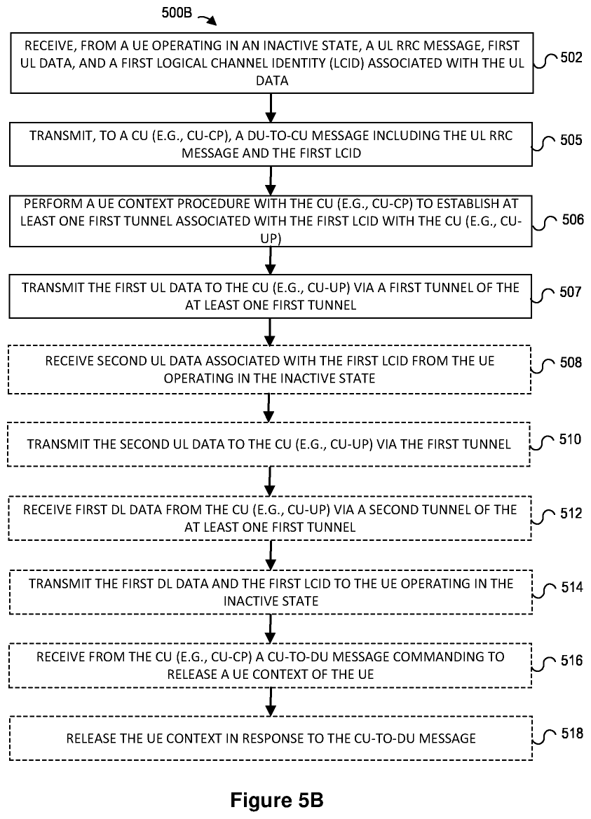

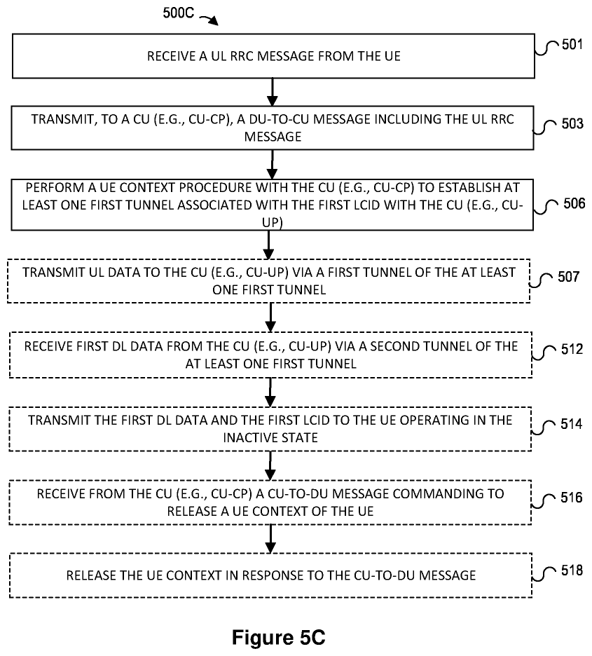

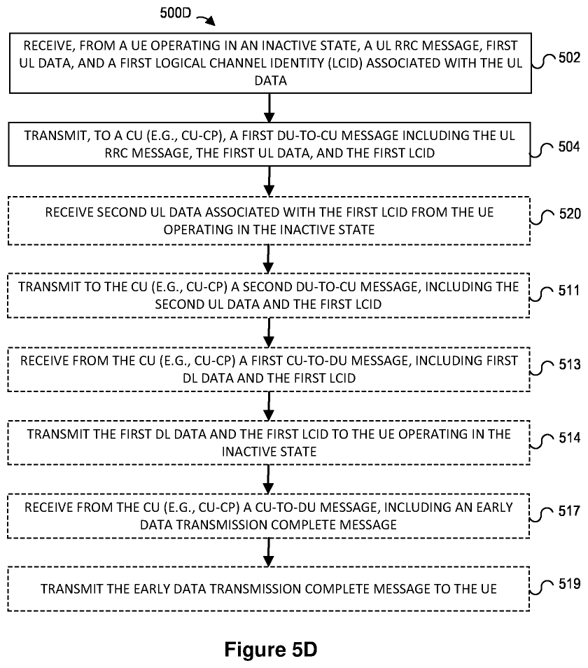

Next, several example methods that can be implemented in a DU, a CU, or a base station are discussed with reference to FIGS. 5A-16. Each of these methods can be implemented using processing hardware such as one or more processors to execute instructions stored on a non-transitory computer-readable medium such as computer memory.

Referring first to FIG. 5A, a method 500A can be implemented in a suitable DU and includes transmitting an uplink data packet to a CU, performing a UE context procedure to establish a tunnel between the DU and the CU, and transmitting, via the tunnel, further uplink data. For clarity, the method 500A is discussed with specific reference to the DU 174, the CU 172, and the UE 102.

At block 502, the DU 174 receives, from the UE 102 operating in an inactive or idle state, an uplink message that includes an uplink control (e.g., RRC) message, a first UL data packet, and a first identifier associated with the UL data packet, such as an LCID (e.g., event 304/305 of FIGS. 3B and 3D). In some implementations, the DU 174 receives multiple uplink messages, each including a portion of the first UL data packet (e.g., event 330 of FIGS. 3C-3D). In further implementations, the uplink message includes a first radio bearer identity (RB ID or RBID) rather than LCID. The uplink RRC message may also include MAC-I. Each uplink message may also include a (first) LCID. Depending on the implementation, the CU 172 may configure the first LCID and a first RB ID for the UE 102 before causing the UE to transition to an inactive state.

At block 504, the DU 174 transmits, to a CU-CP 172A, a DU-to-CU message including the uplink RRC message, the first UL data packet, and the first LCID (e.g., event 306 of FIGS. 3B and 3D). After transmitting the DU-to-CU message at block 504, the DU 174 performs, at block 506, a UE context procedure with the CU-CP 172A to establish at least one first tunnel associated with the first LCID with the CU-UP 172B (e.g., events 308/310 of FIGS. 3B and 3D). The tunnel established at block 506 is an uplink tunnel, independent from a downlink tunnel. In some implementations, the DU 174 may establish both an uplink and downlink tunnel (e.g., events 381 and 383 of FIG. 3B). In other implementations, such as in FIG. 3D, the DU 174 may establish only an uplink tunnel (e.g., events 391 and 393 of FIG. 3D). In some implementations, the UE context procedure may be a UE context setup procedure or a UE context modification procedure. In further implementations, the DU 174 performs the UE context procedure with the CU 172 after transmitting the DU-to-CU message at block 504 and, depending on the implementation, to resume transmission to the UE 102. The DU 174 may receive a request from the CU 172 while performing the UE context procedure at block 506 to establish a tunnel, when a radio bearer is configured for EDT. Similarly, the CU 172 may refrain from sending such a request to the DU 174 when the radio bearer is not configured for EDT. In some implementations, the DU 174 may receive a request from the CU 172 to establish a tunnel regardless of whether the radio bearer is configured for EDT.

After establishing the tunnel, the flow proceeds to block 508, where the DU 174 receives a second UL data packet and the first LCID from the UE 102. Then, at block 510, the DU 174 transmits the second UL data packet to the CU-UP 172B via the first tunnel (e.g., event 334 of FIG. 3F). Depending on the implementation, the DU 174 may transmit the UL data packet via an uplink tunnel portion of the first tunnel or by a tunnel dedicated to uplink data transfer. Subsequently to, before, or in parallel with the DU 174 transmitting the UL data packet, the DU 174 may receive a first DL data packet from the CU-UP 172B via the at least one first tunnel (e.g., event 319 of FIGS. 3B, 3C, 3F, and 3H), at block 512. In some implementations, the DU 174 may receive the DL data packet via a downlink tunnel portion of the first tunnel or via a tunnel dedicated to downlink data transfer. In response to receiving the first DL data packet, the DU 174 transmits the first downlink data and the first LCID to the UE 102 (e.g., events 327/328 of FIGS. 3B and 3C and events 382/393 of FIGS. 3F and 3H), at block 514. Depending on the implementation, the DU 174 may segment the first DL data packet and transmit the segmented DL data packet in multiple downlink messages to the UE 102 (e.g., events 332 and 327 of FIG. 3C and events 382/393 of FIGS. 3F and 3H).

At block 516, the DU 174 receives a CU-to-DU message from the CU-CP 172A (e.g., event 325/326 of FIGS. 3B, 3C, 3F, and 3H). The message can instruct the DU 174 to release a UE context. In response, at block 518, the DU 174 releases the UE context. In some implementations, the CU-to-DU message includes a release indication. In other implementations, the CU-to-DU message is a UE context release command. Depending on the implementation, the UE context includes RLC, MAC and/or PHY configurations, RLC and/or MAC entities, TEIDs of the tunnels, and/or software/hardware components that the DU 174 used to receive the UL data packet and/or transmit the DL data packet to the UE 102.

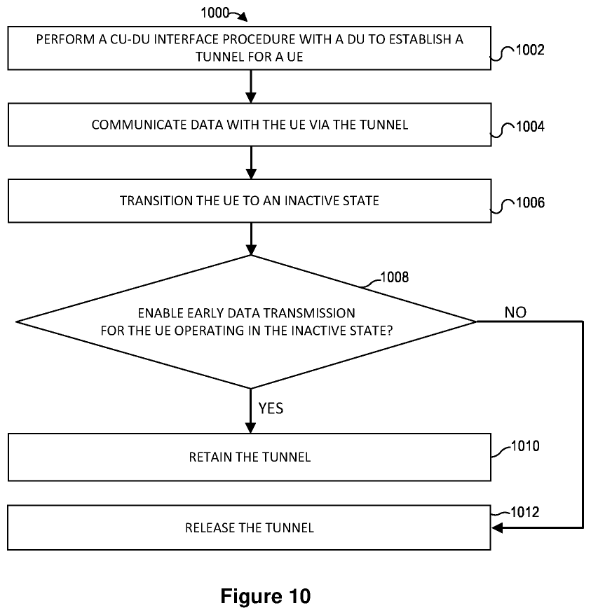

In further implementations, the DU 174 can receive a CU-to-DU message from the CU 172, instructing the DU 174 to suspend transmissions to the UE 102. The DU 174 may suspend transmission to the UE 102 if the CU-to-DU message indicates to the DU 174 to suspend transmission. In some implementations, the DU 174 retains RLC, MAC and/or PHYS configurations, RLC and/or MAC entities, TEIDs of the tunnels, and/or software/hardware components that the DU 174 used to receive UL data packets and/or transmit DL data packets to the UE 102. In some implementations, the DU 174 performs a UE context procedure with the CU 172 before causing the UE 102 to transition to an inactive state and the CU 172 may determine to retain the tunnel, as described with regard to FIG. 10 below.

Referring next to FIG. 5B, a scenario 500B is generally similar to the method 500A, but here the DU 174 transmits the first UL data packet to the CU 172 via the established tunnel. Thus, rather than transmitting the first UL data packet to the CU prior to completing the establishment of a tunnel (as is the case in the method 500A), the DU 174 in this scenario transmits all of the UL data packet received during the EDT procedure via a tunnel. More specifically, the differences between the scenarios of FIG. 5A and FIG. 5B are discussed below.

At block 505, the DU 174 transmits a DU-to-CU message, including the uplink RRC message and the first LCID to the CU-CP 172A, but not including the UL data packet (e.g., event 306 of FIGS. 3B-3D, but not including FIG. 3A). At block 507, the DU 174 transmits the UL data packet to the CU-UP 172B directly via the first tunnel (e.g., event 317 of FIGS. 3B and 3D). According to this method, the DU 174 need not send the first UL data packet to the CU-CP 172A.

Next, a method 500C of FIG. 5C also is generally similar to the method 500A. However, the DU 174 according to the method 500C initially receives, from a UE, only an RRC message.

In particular, the DU 174 at block 501 receives, from a UE 102 operating in an inactive or idle state, an uplink RRC message. In some implementations, the DU 174 transmits a paging message to page the UE 102, and the UE 102 transmits the uplink RRC message in response to the paging message. In such implementations, the UE 102 may not necessarily transmit an UL data packet together with the uplink RRC message.

At block 503, the DU 174 transmits, to a CU-CP 172A, a DU-to-CU message including the uplink RRC message (e.g., event 306 of FIGS. 3B-3H, but not including FIG. 3A). After establishing a tunnel at block 506, the DU 174 transmits the UL data packet to the CU-UP 172B directly via the first tunnel (e.g., event 317 of FIGS. 3B and 3D and events 334 and 344 of FIGS. 3F and 3H), at block 507.

Referring next to FIG. 5D, a method 500D also is generally similar to the method 500A, but here the DU 174 communicates further data with the CU 172 only via the CU-CP 172A. In particular, after executing blocks 502 and 504 as discussed above, the DU 174 receives, at block 520, a second UL data packet associated with the first LCID from the UE 102. At block 511, the DU 174 transmits a second DU-to-CU message to the CU-CP 172A, and includes the second UL data packet and the first LCID in the message (e.g., event 335 of FIG. 3E).

Prior to, subsequently to, or in parallel with steps 520 and 511, the DU 174 may receive 513 a first CU-to-DU message from the CU-CP 172A, the message including a first DL data packet and the first LCID (e.g., events 325/326 of FIGS. 3A, 3D, 3E, and 3G). The DU 174 can transmit the first DL data packet and the first LCID to the UE 102 (events 327/328 of FIGS. 3A, 3D, 3E, and 3G), at block 514. In some implementations, at block 517, the DU 174 receives 517 a CU-to-DU message from the CU-CP 172A, the message including an indication that the early data transmission is complete. At block 519, the DU 174 transmits an EDT complete indication to the UE 102. In some implementations, the EDT complete message may be an RRC release message or may be an RRCEarlyDataComplete message.

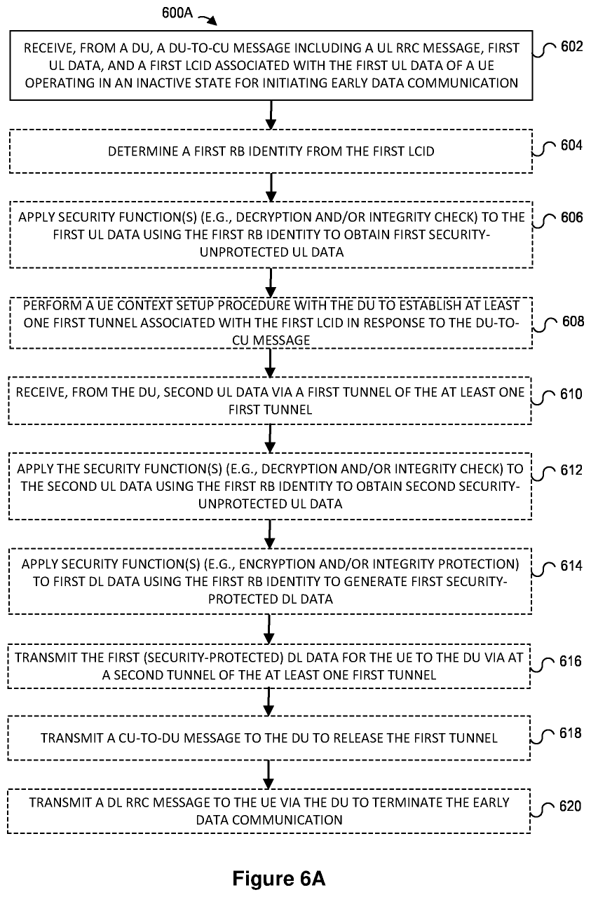

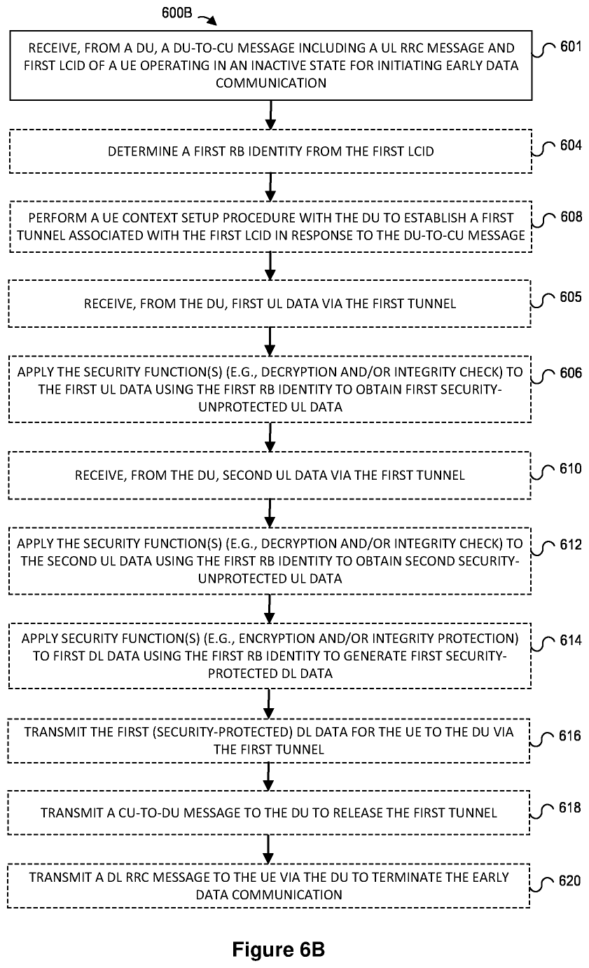

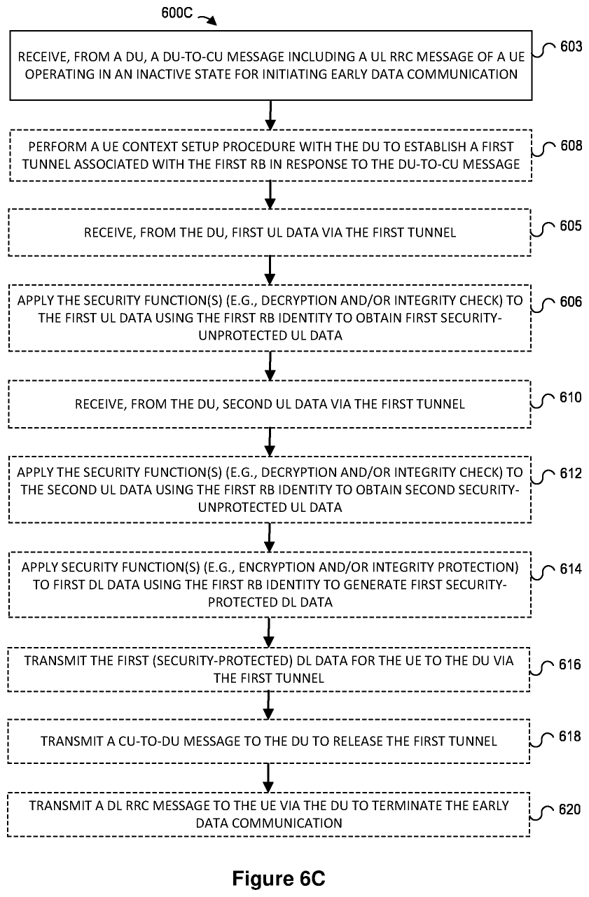

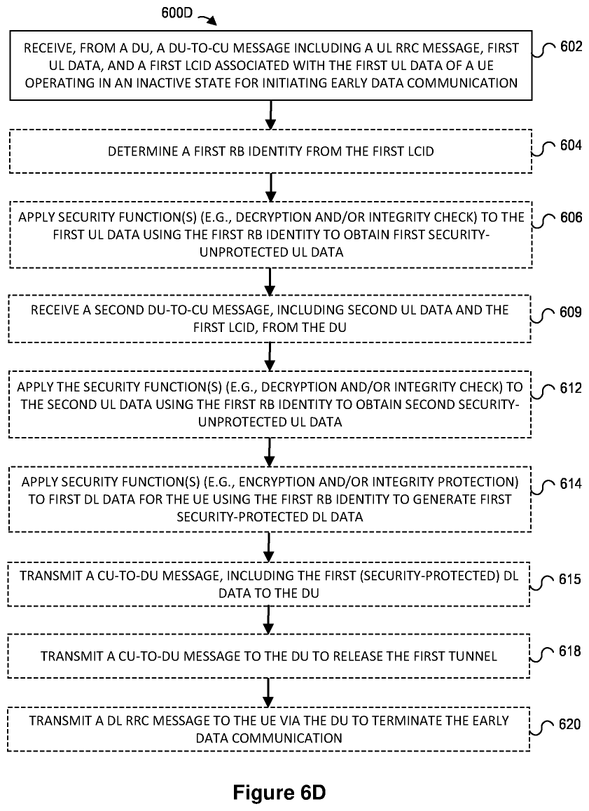

Referring next to FIG. 6A, a method 600A can be implemented in a suitable CU such as the CU 172. The method 600A includes performing security functions on received data, establishing a tunnel between the CU 172 and the DU 174 using an LCID, and transmitting the secure data to the DU 174 via the tunnel.

At block 602, the CU 172 receives, from a DU 174, a DU-to-CU message including an uplink RRC message, a first UL data packet, and a first LCID associated with the first uplink data of a UE 102 operating in an inactive state for initiating early data communication (e.g., event 306 of FIGS. 3B and 3D). At block 604, the CU 172 determines a first RB ID based on the first LCID. In some implementations, the first LCID is associated with the first RB ID. The CU 172 may configure the first LCID and the first RB ID for the UE 102 before causing the UE 102 to transition to an inactive state. In further implementations, the CU 172 may receive the RB ID directly, and the CU 172 may omit block 604 and proceed directly to block 606. After the CU 172 determines the first RB ID at block 604, the CU 172 at block 606 uses the RB ID to apply security functions to the first UL data packet to obtain a first security-unprotected data packet. In some implementations, the security function may be one or both of a decryption function and/or an integrity check function as described above.

Subsequently to, prior to, or in parallel with blocks 604 and 606, the CU 172 may, in response to receiving the DU-to-CU message, perform a UE context setup procedure with the DU 174 at block 608, so as to establish at least one first tunnel associated with the first LCID (e.g., events 308/310 of FIGS. 3B and 3D). At block 610, the CU 172 receives 610 a second UL data packet from the DU 174 (e.g., events 334/335/344/345 of FIGS. 3F and 3H). Depending on the implementation, the CU 172 may receive the UL data packet via an uplink tunnel portion of the first tunnel or by a tunnel dedicated to uplink data transfer (e.g., event 334 of FIG. 3F). At block 612, the CU 172 applies security functions to the second UL data packet using the first RB ID to obtain a second security-unprotected data packet. Similar to block 606, the security function may be one or both of a decryption function and/or an integrity check function.

In some implementations, the CU 172 may establish additional tunnels, each associated with a particular LCID. For example, the CU 172 may establish at least one second tunnel for a second LCID with the DU 174. The CU 172 may determine a second RB ID based on the second LCID and may later receive a third UL data packet from the DU 174 via the second tunnel. The CU 172 may also apply the security functions to the third UL data packet using the second RB ID. In further implementations, the CU 172 may request the DU 174 to establish the second tunnel if the second radio bearer is configured for EDT or may refrain from requesting the DU 174 to establish the second tunnel if the radio bearer is not configured for EDT. In some implementations, the CU 172 may request for the DU 174 to establish the tunnel regardless of whether the radio bearer is configured for EDT.

At block 614, the CU 172 may apply one or more security functions to a first DL data packet using the first RB ID to generate a first security-protected data packet. The one or more security functions may be one or both of an encryption function and/or an integrity protection function, as described above. Next, at block 615, the CU 172 transmits the first security-protected DL data packet for the UE 102 to the DU 174 via the tunnel established at block 608 (e.g., event 319 of FIGS. 3B, 3C, 3F, and 3H). Depending on the implementation, the CU 172 may transmit the DL data packet via a downlink tunnel portion of the first tunnel or by a tunnel dedicated to downlink data transfer, at block 616.

At block 618, the CU 172 transmits a CU-to-DU message to the DU 174 to release the first tunnel (e.g., event 325 of FIGS. 3B, 3C, 3F and 3H). The CU 172 transmits a downlink RRC message (or, depending on the implementation, a MAC-I) for the UE 102 to the DU 174 to terminate the early data communication (e.g., event 325 of FIGS. 3B, 3C, 3F, and 3H), at block 620. The CU 172 may determine to transmit one or both of the messages to the DU 174 in response to determining to stop the early data communication. The CU 172 may further release the first tunnel in response to determining to transmit the CU-to-DU message. In some implementations, the CU-to-DU message may be a UE context release command message. In further implementations, the CU 172 may transmit the downlink RRC message in the CU-to-DU message. The CU 172 may apply the security functions to a second DL data packet using a second RB ID to obtain a second security-protected DL data packet. The CU 172 may then transmit the second security-protected DL data packet to the DU 174 via the second tunnel.

Referring next to FIG. 6B, a method 600B is generally similar to 600A. However, here the CU 172 receives the first uplink data via the established tunnel.

At block 601, the CU 172 receives, from a DU 174, a DU-to-CU message including an uplink RRC message and a first LCID of a UE 102 operating in an inactive state for initiating early data communication (e.g., event 306 of FIGS. 3B and 3D). After executing blocks 604 and 608 as discussed above, the CU 172 at block 605 receives, from the DU 174, a first UL data packet via the first tunnel (e.g., event 317 of FIGS. 3A-3H). Depending on the implementation, the CU 172 may receive the UL data packet via an uplink tunnel portion of the first tunnel or by a tunnel dedicated to uplink data transfer. The CU 172 then, after applying the security functions at block 606, receives a second UL data packet from the DU 174 (e.g., events 334/344 of FIGS. 3F and 3H), at block 610.

Referring next to FIG. 6C, a method 600C is generally similar to the method 600A, but here the CU 172 does not receive uplink data in the initial DU-to-CU message. At block 603, the CU 172 receives, from a DU 174, a DU-to-CU message including an uplink RRC message of a UE 102 operating in an inactive state for initiating early data communication (e.g., event 306 of FIGS. 3B and 3D). At block 608, the CU 172 performs 608 a UE context setup procedure with the DU 174 to establish a first tunnel associated with a first radio bearer in response to the DU-to-CU message (e.g., events 308/310 of FIGS. 3B and 3D), and then proceeds to block 605, where the CU 172 receives a first UL data packet via the first tunnel (e.g., event 317 of FIGS. 3B and 3D).

Now referring to FIG. 6D, a method 600D also is generally similar to the method 600A. However, according to the method 600D, the CU 172 and the DU 174 communicate data only via the CU-CP 172A. After executing block 602, 604, and 606 as discussed below, the CU 172 at block 609 receives a second DU-to-CU message from the DU 174, including a second UL data packet and the first LCID (e.g., events 335/345 of FIGS. 3F and 3H).

In some implementations, the CU 172 may receive a third DU-to-CU message from the DU 174, the message including a third UL data packet and a second LCID associated with the third UL data packet (e.g., events 335/345 of FIGS. 3F and 3H). The second LCID may be associated with a second radio bearer or a second RB ID. The CU 172 may, then, determine the second RB ID from the second LCID and apply security functions to the third UL data packet using the second RB ID as described above. In further implementations, the CU 172 may apply the security functions to a second DL data packet using the second RB ID to obtain a second security-protected DL data packet. The CU 172 then transmits a CU-to-DU message, including the second security-protected DL data packet and the second LCID, to the DU 174 (e.g., events 337/347 of FIGS. 3F and 3H). The DU 174 may transmit at least a portion of the second security-protected DL data packet and the second LCID to the UE 102.

Referring next to FIG. 7, a method 700 can be implemented in the DU 174 (or another suitable DU) and includes receiving downlink data and a radio bearer identification (RB ID) from the CU 172 and determining an LCID based on the RB ID.

At block 702, the DU 174 performs early data communication with a UE 102 operating in an inactive state (e.g., events 380/381/390/391 of FIGS. 3A-3H). At block 704, the DU 174 receives a CU-to-DU message from the CU 172, the message including downlink data and an RB ID associated with the downlink data (e.g., event 326 of FIGS. 3B and 3C). At block 706, the DU 174 uses the RB ID to determine an LCID.

Next, at block 708, the DU 174 generates a downlink message, which includes the DL data packet and the LCID. In some implementations, the DU 174 receives an LCID in the CU-to-DU message instead of the RB ID. In such implementations, the DU 174 may proceed directly to generating the downlink message.

In some implementations, the downlink message may be a downlink MAC PDU. In further implementations, the downlink message may include only a portion of the DL data packet, such as a segment. After generating the downlink message at block 708, the DU 174 at block 710 transmits the downlink message to the UE 102 (e.g., events 327/328 or 332 of FIGS. 3B and 3C). In some implementations, the CU 172 may send a configuration including the LCID and the RB ID to the UE 102 before causing the UE 102 to transition to an inactive state. In further implementations, the CU 172 may receive the configuration from the DU 174 before causing the UE 102 to transition to an inactive state.

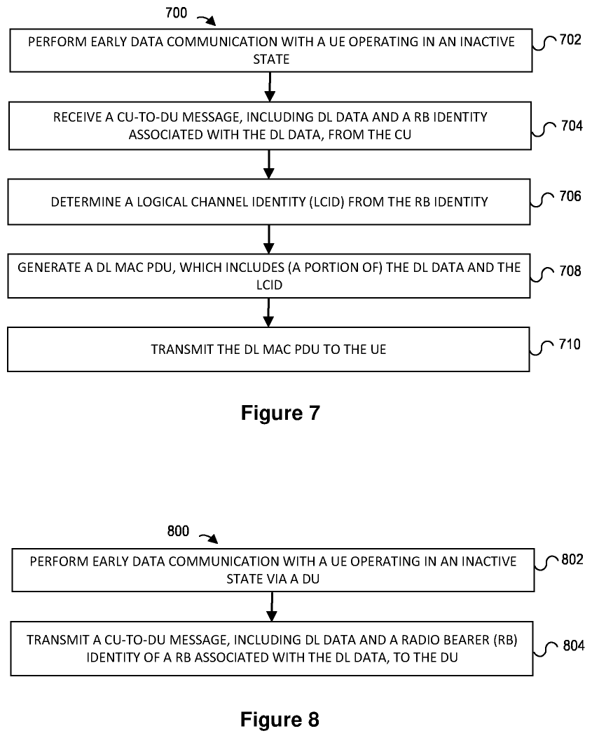

Referring next to FIG. 8, a method 800 for performing EDT with a UE 102 via a DU 174 can be implemented in the CU 172 or another suitable CU.

At block 802, the CU 172 performs early data communication with a UE 102 operating in an inactive state via a DU 174 (e.g., events 380/381/390/391 of FIGS. 3A-3H). At block 804, the CU 172 transmits a CU-to-DU message to the DU 174, the message including a DL data packet and an RB ID for a radio bearer associated with the DL data packet (e.g., event 326 of FIGS. 3A and 3D). In some implementations, an LCID is associated with the radio bearer/DRB or the RB ID. The CU 172 may, prior to the UE 102 transitioning to an inactive state, configure the LCID and the RB ID for the UE 102. In further implementations, the CU 172 may transmit a CU-to-DU message including a DL data packet and an LCID rather than an RB ID. In still further implementations, the CU 172 may receive the DL data packet from a CN 110 or an edge server. The CU 172 may then determine the LCID or RB ID based on a quality of service (QOS) flow ID of the DL data packet. For example, the CU 172 may determine the LCID or the RB ID based on a one-to-one mapping between the LCID or RB ID and the QoS flow ID.

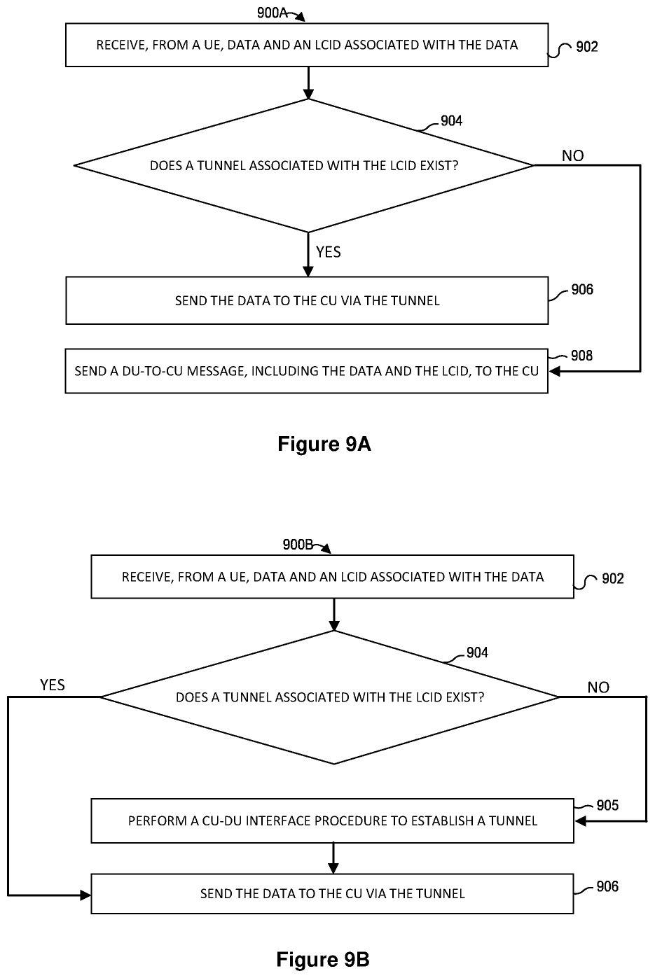

Now referring to FIG. 9A, a method 900A includes determining whether to communicate data with the CU 172 via a tunnel or by way of a DU-to-CU message to the CU-CP 172A, based on whether a tunnel associated with an LCID exists. The method 900A can be implemented in the DU 174 or another suitable DU.

At block 902, the DU 174 receives, from a UE 102, a data packet and an LCID associated with the data packet (e.g., events 304/305 of FIGS. 3A-3D). In some implementations, the UE 102 may transmit the data packet and the LCID separately. At block 904, the DU 174 then determines whether a tunnel associated with the received LCID exists. In some implementations, the DU 174 may specifically determine whether a GTP-U tunnel associated with the LCID exists. If a tunnel does exist, the flow proceeds to block 906, where the DU 174 sends the data packet to the CU 172 via the tunnel (e.g., event 317 of FIGS. 3B and 3D). If a tunnel does not exist, the flow proceeds to block 908, where the DU 174 transmits the data packet to the CU 172 via a DU-to-CU message, the message also including the LCID (e.g., events 306/315 and 316 of FIGS. 3A and 3C).

Referring next to FIG. 9B, a method 900B also can be implemented in the DU 174 or another suitable DU. This method includes determining whether to establish a tunnel between the CU 172 and the DU 174 based on whether a tunnel associated with an LCID exists.

If the DU 174 at block 904 determines that a tunnel exists, the flow proceeds to block 906. Otherwise, if a tunnel does not exist, the flow proceeds to block 905, where the DU 174 performs a CU-DU interface procedure to establish a tunnel before transmitting the data packet to the CU 172 via the tunnel (e.g., events 308/310 and 317 of FIGS. 3B and 3D).

Referring next to FIG. 10, a method 1000 can be implemented in a suitable CU (e.g., the CU 172) and includes determining whether to retain or release a previously established tunnel based on whether EDT is enabled for the UE.

At block 1002, the CU 172 performs a CU-DU interface procedure with a DU 174 to establish a tunnel for a UE 102. At block 1004, the CU 172 communicates data with the UE 102 via the tunnel. At block 1006, the CU 172 causes the UE 102 to transition to an inactive state (e.g., event 302 of FIGS. 3A-3D). The CU 172 may refrain from transmitting a CU-to-DU message to the DU 174 to release the tunnel in response to causing the UE 102 to transition to an inactive state. Further, the UE 102 can transmit a CU-to-DU message to the DU 174 to suspend transmission to the UE 102 in response to causing the UE 102 to transition to an inactive state.

At block 1008, the CU 172 then determines whether to enable EDT for the UE 102 operating in an inactive state. If the CU 172 determines to enable EDT, the flow proceeds to block 1010, where the CU 172 retains the tunnel. If the CU 172 determines not to enable EDT, the flow proceeds to block 1012, where the CU 172 releases the tunnel (e.g., events 325/326 of FIGS. 3A-3D). In some implementations, the tunnel is associated with a logical channel that the DU 174 configures for the UE 102. In further implementations, the tunnel is associated with a radio bearer that the CU 172 configures for the UE 102. In still further implementations, the tunnel is a GTP-U tunnel.

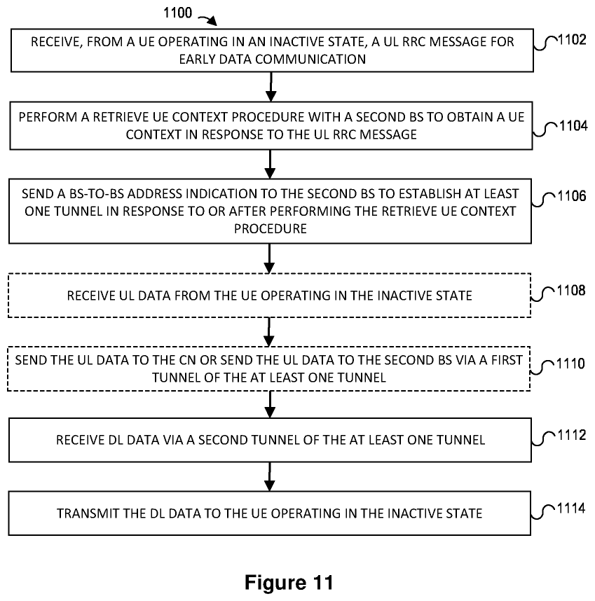

Referring next to FIG. 11, a method 1100 can be implemented in a base station, such as the base station 104, and includes communicating with a second base station (with which the UE 102 has previously communicated), retrieving UE context information for the UE 102, and establishing a tunnel using a BS-to-BS address indication, implemented in a first base station 104.

At block 1102, a first BS 104 receives 1102, at a DU 174 of the first BS 104 and from a UE 102 operating in an inactive state, an uplink RRC message for early data communication (e.g., event 404 of FIGS. 4A-4B). At block 1104, the base station 104 then performs, at a CU 172, a retrieve UE context procedure with the base station 106 to obtain a UE context in response to the uplink RRC message (e.g., events 432/433/434 of FIGS. 4A-4B). In some implementations, the base station 106 may have previously communicated with the UE 102.

After performing the retrieve UE context procedure, at block 1106, the first base station 104 transmits a BS-to-BS address indication to the base station 106 from the CU 172 to establish at least one tunnel (e.g., event 439 of FIGS. 4A-4B). In some implementations, the base station 104 transmits 1106 the BS-to-BS address indication in response to performing the retrieve UE context procedure. In further implementations, the BS-to-BS address indication can be an Xn-U address indication or a Data Forwarding Address Indication. Depending on the implementation, the base station 104 may transmit the BS-to-BS address indication in response to performing a bearer context setup procedure to establish at least one tunnel or a bearer context modification procedure to modify at least one tunnel. In further implementations, the base station 104 may perform a bearer context modification procedure to modify at least one tunnel in response to transmitting 1106 the BS-to-BS address indication.

At block 1108, the base station 104 may then receive an UL data packet at the DU 174 (e.g., event 417 of FIGS. 4A-4B) and from the UE 102 operating in an inactive state before subsequently transmitting 1110 the UL data packet to a core network (CN) 110 via the CU 172. In some implementations, the base station 104 instead transmits, at block 1110, the UL data packet to the base station 106 via the at least one tunnel (e.g., event 442 of FIG. 4B). Subsequently to, prior to, or in parallel with blocks 1108 and 1110, the base station 104 may receive a DL data packet via the at least one tunnel at the DU 174 (e.g., events 444/445 of FIGS. 4A-4B) (block 1112) and transmit the downlink data to the UE 102 operating in an inactive state (e.g., event 436 of FIGS. 4A-4B) (block 1114). Depending on the implementation, the base station 104 may receive the DL data packet via a downlink tunnel portion of the first tunnel or by a tunnel dedicated to downlink data transfer.

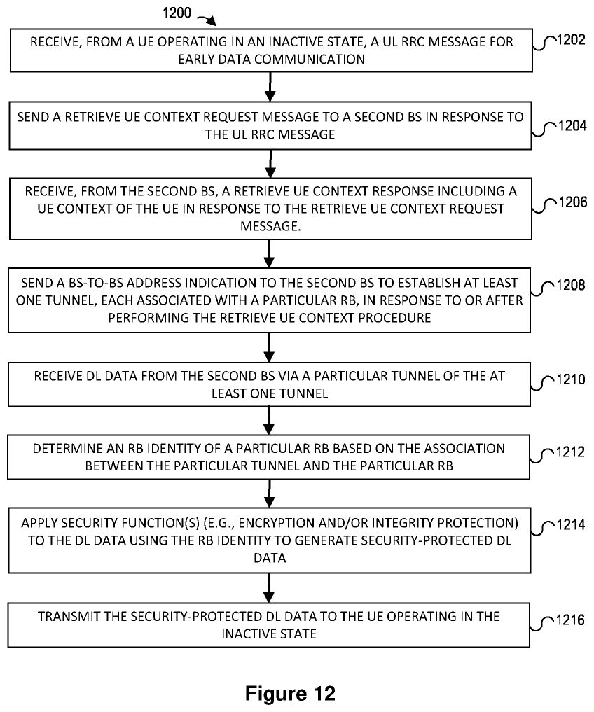

Referring next to FIG. 12, a method 1200 includes communicating with a second BS 106 with which the UE 102 has previously communicated, retrieving UE context information for the UE 102, establishing a tunnel, applying security functions, and transmitting protected downlink data to the UE 102. This method also can be implemented in a first base station, e.g., the base station 104.

At block 1202, the base station 104 receives, from a UE 102 operating in an inactive state and at a DU 174, an uplink RRC message for early data communication (e.g., event 404 of FIGS. 4A-4B). At block 1204, the base station 104 transmits a retrieve UE context request to a second BS 106 from the CU 172 (e.g., event 432 of FIGS. 4A-4B). At block 1206, the base station 104 receives, from the second BS 106 and at the CU 172, a retrieve UE context response (e.g., event 433 of FIG. 4A). In some implementations, the UE context response includes at least a UE context of the UE 102.

At block 1208, the base station 104 transmits a BS-to-BS address indication to the second base station to establish at least one tunnel, each associated with a particular radio bearer (e.g., event 439 of FIG. 4A). In some implementations, the base station 104 transmit the indication in response to performing 1204/1206 the retrieve UE context procedure, at block 1208. Depending on the implementation, the base station 104 may transmit the BS-to-BS address indication from the CU 172 of the first BS 104. At block 1210, the base station 104 then receives a DL data packet from the base station 106 via the established tunnel (e.g., event 445 of FIG. 4A) and determines, at block 1212, an RB ID of a particular radio bearer based on the association between the particular tunnel and the particular radio bearer.

At block 1214, the base station 104 applies one or more security functions to the downlink data using the RB ID to generate a security-protected DL data packet and transmits, at block 1216, the security-protected DL data packet to the UE 102 operating in an inactive state (e.g., event 436 of FIG. 4A).

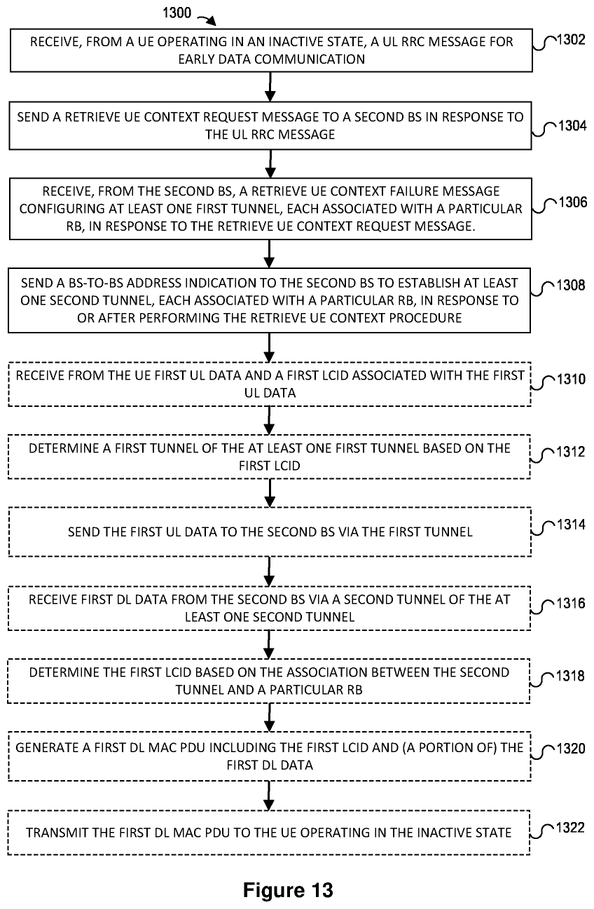

Referring next to FIG. 13, a method 1300 can be implemented in a base station 104 for example. In method 1300, the base station 104 communicates with a second base station 106 with which the UE 102 has previously communicated, similar to methods 1100 and 1200. Method 1300 differs from methods 1100 and 1200 in that the base station 106 returns a retrieve UE context failure rather than a successful retrieve UE context response.

At block 1302, a base station 104 receives, from a UE 102 operating in an inactive state and at a DU 174, an uplink RRC message for early data communication (e.g., event 404 of FIGS. 4A-4B). At block 1304, the base station 104 transmits, from the CU 172, a retrieve UE context request message to a second base station 106 (e.g., event 432 of FIG. 4A-4B). At block 1306, the first BS 104 receives, from the second BS 106 and at the CU 172 of the first BS 104, a retrieve UE context failure message (e.g., event 434 of FIG. 4B). In some implementations, the retrieve UE context failure message configures at least one first tunnel, each tunnel associated with a particular radio bearer. In such implementations, the base station 104 may establish a third tunnel, as the retrieve UE context failure configures the third tunnel associated with a second LCID. The base station 104 may then receive a second UL data packet and a second LCID from the UE 102 and subsequently determine that the second LCID is associated with the third tunnel and send the second uplink data to the base station 106.

At block 1308, the base station 104 transmits a BS-to-BS address indication to the second base station 106 (e.g., event 439 of FIG. 4B). In some implementations, the base station 104 transmits the BS-to-BS address indication to establish at least one second tunnel, each tunnel associated with a particular radio bearer. In further implementations, the BS-to-BS address indication message is an Xn-U address indication or a Data Forwarding Address Indication message. In still further implementations, the base station 104 may transmit the BS-to-BS address indication message to additionally establish a fourth tunnel associated with the second LCID. The base station 104 may receive a second DL data packet and the second LCID from the base station 106. The base station 104 then determines that the fourth tunnel is associated with the second LCID and, in response, generates a second downlink message including the second LCID and at least a portion of the second DL data packet.

At block 1310, the base station 104 may receive, from the UE 102 and at a DU 174 of the base station 104, a first UL data packet and a first LCID associated with the first UL data packet (e.g., events 404, 417, or 434 of FIG. 4B). After receiving the first UL data packet and the first LCID, the base station 104 may determine, at block 1312, a first tunnel based on the first LCID. Subsequently, at block 1314, the base station 104 may transmit the first UL data packet to the second base station 106 via the first tunnel (e.g., event 442 of FIG. 4B). At block 1316, the base station 104 may then receive a first DL data packet from the base station 106 via a second tunnel (e.g., event 444 of FIG. 4B).

At block 1318, the base station 104 may determine, based on the association between the second tunnel and a particular radio bearer, an LCID. At block 1320, the BS 104 can generate a first downlink message including the LCID and the first DL data packet and transmit, at block 1322, the first downlink message to the UE 102 operating in an inactive state (e.g., events 436 or 492 of FIG. 4B). In some implementations, the base station 104 may generate a first downlink message including the LCID and a portion of the first DL data packet, such as a first segment (e.g., events 436 or 492 of FIG. 4B). Depending on the implementation, blocks 1316, 1318, 1320, and 1322 may occur before, after, or in parallel with blocks 1310, 1312, and 1314.

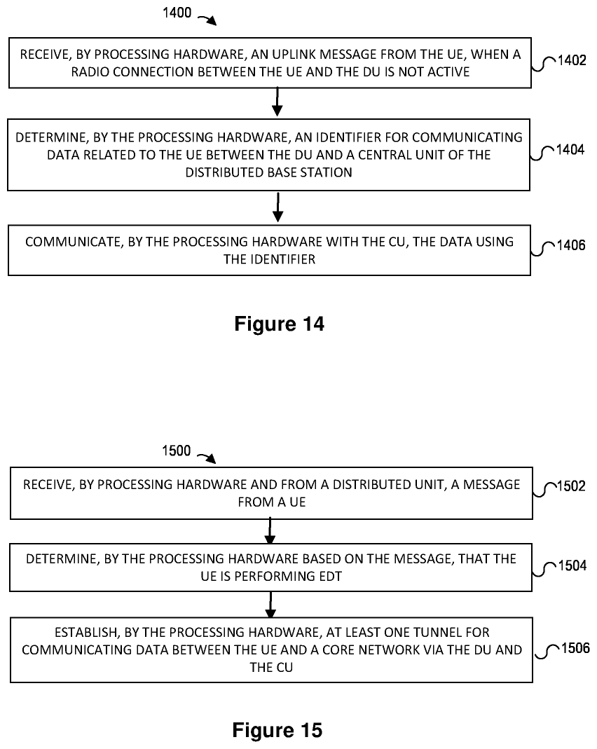

Now referring to FIG. 14, a method 1400 for processing EDT can be implemented in a DU such as the DU 174.

At block 1402, the DU 174 receives an uplink message from the UE 102, when a radio connection between the UE 102 and the DU 174 is not active (e.g., events 304/404 of FIGS. 3A-4B, blocks 501/502 of FIGS. 5A-D, and blocks 1102/1202/1302 of FIGS. 11-13). At block 1404, the DU 174 determines an identifier for communicating data related to the UE 102 between the DU 174 and a CU 172 of the distributed base station 104 (e.g., block 502 of FIGS. 5A, 5B, and 5D and blocks 704/706 of FIG. 7). At block 1406, the DU 174 communicates, with the CU 172, the data using the identifier (e.g., events 306, 315, 317, and 319 of FIGS. 3A-3D, events 406 and 417 of FIGS. 4A and 4B, blocks 504, 507, 510, 511, 512, and 513 of FIGS. 5A-5D, and block 1110 of FIG. 11). The data can include uplink or downlink data, first or subsequent data, and segmented or non-segmented data.

Referring next to FIG. 15, a method 1500 is a method for processing EDT, which can be implemented in a CU 172 or another suitable CU.

At block 1502, the CU 172 receives, from a DU 174 a message from a UE 102 (e.g., events 306 and 406 of FIGS. 3B, 3D, 4A, and 4B and blocks 601, 602, and 603 of FIGS. 6A-6D). The CU 172 then determines, at block 1504, based on the message, that the UE 102 is performing EDT (e.g., block 802 of FIG. 8). At block 1506, the CU 172 establishes at least one tunnel for communicating data between the UE and a core network via the DU 174 and the CU 172 (e.g., events 308/310 and 408/410 of FIGS. 3A-4B, block 608 of FIGS. 6A-6C, and blocks 1106, 1208, and 1308 of FIGS. 11, 12, and 13).

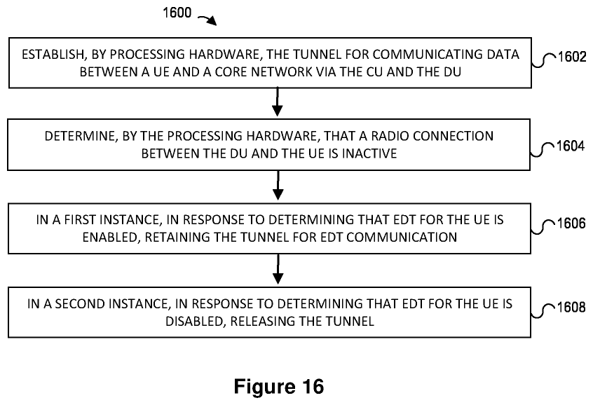

Referring next to FIG. 16, a method 1600 is a method in a CU 172 or another suitable CU for establishing and retaining or releasing a tunnel.

At block 1602, the CU 172 establishes a tunnel for communicating data between a UE 102 and a core network via the CU 172 and the DU 174 (e.g., events 308/310 and 408/410 of FIGS. 3A-4B, block 608 of FIGS. 6A-6C, block 1002 of FIG. 10, and blocks 1106, 1208, and 1308 of FIGS. 11, 12, and 13). At block 1604, the CU 172 determines that a radio connection between the DU 174 and the UE 102 is inactive (e.g., block 1006 of FIG. 10). In response to determining that EDT for the UE 102 is enabled, the CU 172 in a first instance (block 1606) retains the tunnel for EDT communication (e.g., block 1010 of FIG. 10). In response to determining that EDT for the UE 102 is disabled, the CU 172 in a second instance (block 1608) releases the tunnel (e.g., block 1012 of FIG. 10).

The following list of examples reflects a variety of the embodiments explicitly contemplated by the present disclosure:

Example 1. A method, in a distributed unit (DU) of a distributed base station, for managing an early data transmission (EDT) from a UE, the method comprising: receiving, by processing hardware, an uplink message from the UE, when a radio connection between the UE and the DU is not active; determining, by the processing hardware, an identifier for communicating data related to the UE between the DU and a central unit (CU) of the distributed base station; and communicating, by the processing hardware with the CU, the data using the identifier.

Example 2. The method of example 1, further comprising: maintaining a context for the UE in a memory, when the UE transitions from a connected state associated with a protocol for controlling radio resources to an inactive or idle state associated with the protocol, wherein the determining includes using the context.

Example 3. The method of example 2, wherein the context includes at least one of: (i) F1 Application Protocol identity (F1AP ID), (ii) W1 Application Protocol identity (W1AP ID), (iii) a radio bearer (RB) identity (RBID), (iv) an F1-U uplink tunnel endpoint identifier (F1-U UL TEID), (v) an F1-U downlink TEID (F1-U DL TEID), (vi) a W1-U UL TEID, (vii) a W1-U DL TEID, (viii) a radio link control (RLC) configuration, (ix) a media access control (MAC) configuration, (x) a physical layer (PHY) configuration, or (xi) a cell group configuration.

Example 4. The method of example 2 or 3, further comprising: receiving, by the processing hardware from the UE, a logical channel identifier (LCID); determining the identifier using the context and the LCID.

Example 5. The method of any of examples 2-4, further comprising: performing, by the processing hardware and in response to receiving the uplink message, a bearer context modification procedure with the CU, to resume a use of the context.

Example 6. The method of example 1, further comprising: discarding, by the processing hardware, a context for the UE when the UE transitions from a connected state associated with the protocol to an inactive or idle state associated with the protocol; and performing, by the processing hardware, a context setup procedure with the CU to generate at least one TEID.

Example 7. The method of example 6, further comprising: receiving, by the processing hardware from the UE, at least one of an LCID or an RBID; transmitting, by the processing hardware to the CU, the LCID or the RBID; and receiving, by the processing hardware from the CU, a request to set up the context for the UE.

Example 8. The method of example 6 or 7, further comprising: receiving, by the processing hardware from the CU, an uplink (UL) TEID.

Example 9. The method of any of examples 6-8, further comprising: allocating, by the processing hardware, a downlink (DL) TEID; and transmitting, by the processing hardware, the DL TEID to the CU.

Example 10. The method of any of examples 2-9: releasing the context for the UE in response to a command from the CU.

Example 11. The method of any of the preceding examples, including: receiving, in the uplink message, an uplink data packet along with an uplink control message associated with a protocol for controlling radio resources.

Example 12. The method of any of examples 1-10, including: receiving, by the processing hardware from the UE, the uplink message in a first time slot or a first MAC protocol data unit (PDU), the message including an uplink control message associated with a protocol for controlling radio resources, and receiving, by the processing hardware from the UE, an uplink data packet in a second time slot or a second MAC PDU.

Example 13. The method of example 11 or 12, including: transmitting the uplink data packet to a CU user plane (CU-UP).

Example 14. The method of example 13, including: transmitting the uplink data packet to the CU-UP prior to transmitting the uplink control message to a CU control plane (CU-UP).

Example 15. The method of example 13, including: transmitting the uplink data packet to the CU-UP subsequently to transmitting the uplink control message to a CU control plane (CU-UP).

Example 16. The method of example 11 or 12, including: transmitting the uplink data packet to the CU-CP.

Example 17. The method of example 16, wherein the transmitting includes: transmitting the uplink data packet and the uplink control message in an Initial UL RRC message.

Example 18. The method of any of the preceding examples, wherein communicating the data includes: receiving, from the UE, a plurality of uplink data segments in respective MAC PDUs, subsequently to receiving the uplink message; and transmitting a single data packet comprising the plurality of uplink data segments to the CU-UP or the CU-CP.

Example 19. The method of example 18, further comprising: assembling, by the processing hardware, the plurality of uplink data segments into a single data packet prior to the transmitting the single data packet to the CU.

Example 20. The method of any of the preceding examples, wherein communicating the data includes: receiving, from the UE, a plurality of uplink data packets in respective MAC PDUs, subsequently to receiving the uplink message; and transmitting the plurality of uplink data packets to the CU-UP or the CU-CP.

Example 21. The method of any of examples 1-10 or 13-20, wherein: the uplink message includes an RRC message; the method further comprising: transmitting, to the CU, a transfer message including an RRC message.

Example 22. The method of example 21, wherein the transfer message is one of an Initial UL RRC Message Transfer message or a UL RRC Message Transfer message.

Example 23. The method of example 21 or 22, wherein: transmitting the transfer message includes transmitting an EDT indicator.

Example 24. The method of any of the preceding examples, further comprising: receiving, by the processing hardware, a downlink data packet from the CU; and transmitting, by the processing hardware, the downlink data packet to the UE.

Example 25. The method of example 24, including receiving the downlink data packet along with an RRC command in a CU-to-DU message.

Example 26. The method of example 1, wherein: the receiving includes receiving an uplink data packet and an LCID associated with the uplink data packet; the communicating includes, in response to determining that a tunnel corresponding to the LCID exists, transmitting the uplink data packet to the CU via the tunnel.

Example 27. The method of example 26, wherein the communicating further includes: in a second instance, in response to determining that no tunnel corresponding to the LCID exists, transmitting the uplink data packet and the LCID to the CU in a DU-to-CU message.

Example 28. The method of example 26, wherein the communicating further includes: in a second instance, in response to determining that no tunnel corresponding to the LCID exists, establishing a new tunnel and transmitting the uplink data to the CU via the new tunnel.

Example 29. A method, in a central unit (CU) of a distributed base station, for managing early data transmission (EDT) from a UE, the method comprising: receiving, by processing hardware and from a distributed unit (DU), a message from a UE; determining, by the processing hardware based on the message, that the UE is performing EDT; and establishing, by the processing hardware, at least one tunnel for communicating data between the UE and a core network via the DU and the CU.

Example 30. The method of example 29, wherein the determining includes: receiving, from the DU, an EDT indicator.

Example 31. The method of example 29 or 30, further comprising: performing, by the processing hardware, a bearer context modification procedure with the DU, to resume a use of the context for the UE.

Example 32. The method of example 31, wherein performing the bearer context modification procedure is in response to receiving, from the DU, a TEID for the UE.

Example 33. The method of example 29 or 30, further comprising: performing, by the processing hardware, a context setup procedure with the DU to generate a context for the UE and obtain at least one TEID for the at least one tunnel.

Example 34. The method of example 33, further comprising: receiving, by the processing hardware from the DU, at least one of an LCID or an RBID; and transmitting, by the processing hardware to the DU, a request to set up the context for the UE.

Example 35. The method of example 33, further comprising: receiving, from the DU, a temporary identifier for the UE; resolving, by the processing hardware, the temporary identifier to identify a second base station that provided a most-recent prior serving cell to the UE; and retrieving, by the processing hardware, the context for the UE from the second base station.

Example 36. The method of example 35, further comprising: performing, by the processing hardware, a bearer context setup procedure with the DU.

Example 37. The method of example 36, wherein performing the bearer context setup procedure includes: transmitting, to the DU, a request to setup a bearer context; and receiving, from the DU, a response including an (i) F1-U UL TEID for use between the CU and the UE, and (ii) an Xn-U DL TEID for use between the CU and the second base station.

Example 38. The method of example 37, further comprising: transmitting, by the processing hardware, the Xn-U DL TEID to the second base station.

Example 39. The method of any of examples 34-38, further comprising: receiving, by the processing hardware, the Xn-U UL TEID from the second base station.

Example 40. The method of any of examples 33-39, further comprising: transmitting, by the processing hardware to the DU, an F1 UL TEID.

Example 41. The method of any of examples 33-39, further comprising: receiving, by the processing hardware from the DU, a F1 DL TEID.

Example 42. The method of any of examples 31-41, further comprising: releasing the context for the UE in response to detecting expiry of a UE inactivity timer.

Example 43. The method of any of examples 29-42, including: receiving, from the DU, an uplink data packet at a CU-UP.

Example 44. The method of example 38, including: receiving the uplink data packet at the CU-UP prior to receiving an uplink control message at the CU-UP.

Example 45. The method of example 43, including: receiving the uplink data packet at the CU-UP subsequently to receiving an uplink control message at the CU-UP.

Example 46. The method of any of examples 29-45, wherein communicating the data includes: receiving, from the DU, a plurality of uplink data packets.

Example 47. The method of any of examples 29-46, wherein: receiving the message includes receiving a transfer message including an RRC message from the UE.

Example 48. The method of example 47, wherein the transfer message is one of an Initial UL RRC Message Transfer message or a UL RRC Message Transfer message.

Example 49. The method of any of examples 29-48, further comprising: transmitting, by the processing hardware, a downlink data packet to the DU.

Example 50. The method of example 49, wherein the CU-UP transmits the downlink data packet to the DU via the at least one tunnel.

Example 51. The method of example 49, wherein transmitting the downlink data packet to the DU further comprises: transmitting, from the CU-UP to the CU-CP, the downlink data packet; transmitting, from the CU-CP to the DU, the downlink data along with an RRC command in a CU-to-DU message.

Example 52. The method of example 49, wherein the downlink data packet is a first downlink data packet of a plurality of downlink data packets, further comprising: transmitting, by the processing hardware and after transmitting the first downlink data packet, a remainder of the plurality of downlink data packets to the DU.

Example 53. The method of example 52, wherein the CU-UP transmits the remainder of the plurality of downlink data packets to the DU via the at least one tunnel.

Example 54. The method of example 52, wherein transmitting the remainder of the plurality of downlink data packets to the DU further comprises: transmitting, from the CU-UP to the CU-CP, the remainder of the plurality of downlink data packets; transmitting, from the CU-CP to the DU, the remainder of the plurality of downlink data packets in one or more CU-to-DU messages.

Example 55. A method, in a CU of a distributed base station, for managing a tunnel between the CU and a DU of the base station, the method comprising: establishing, by processing hardware, the tunnel for communicating data between a UE and a core network via the CU and the DU; determining, by the processing hardware, that a radio connection between the DU and the UE is inactive; in a first instance, in response to determining that EDT for the UE is enabled, retaining the tunnel for EDT communication; and in a second instance, in response to determining that EDT for the UE is disabled, releasing the tunnel.

Example 56. The method of example 55, wherein determining that the EDT is enabled or disabled is based on a configuration of the UE.

Example 57. The method of example 55 or 56, wherein determining that the EDT is enabled or disabled is based on a configuration of the base station.

Example 58. The method of any of examples 55-57, wherein establishing the tunnel includes: associating the tunnel with a logical channel with which the DU configures the UE.

Example 59. The method of any of any of examples 55-58, wherein establishing the tunnel includes: associating the tunnel with a logical channel; and configuring the UE to communicate over the logical channel.

Example 60. The method of any of any of examples 55-58, wherein establishing the tunnel includes: configuring the UE with a radio bearer; and associating the tunnel with the radio bearer.

Example 61. An apparatus comprising processing hardware and configured to implement a method according to any of the preceding examples.

The following description may be applied to the description above.

The “early data transmission (EDT)” can be replaced by “small data transmission (SDT)”. The “F1” can be replaced by “W1”. “RB ID” can be replaced by “DRB ID”. If the W1 interface is used between the CU and DU, “CellGroupConfig” described above can be replaced with “RadioResourceConfigDedicated”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method, in a distributed unit (DU) of a distributed base station, for managing an early data transmission (EDT) from a user equipment (UE), the method comprising:
receiving, at the DU, an uplink message from the UE, when a radio connection between the UE and the DU is not active;
determining, based on the uplink message, an identifier for communicating data related to the UE between the DU and a central unit (CU) of the distributed base station; and
communicating, at the DU with the CU, the data using the identifier.

2. The method of claim 1, further comprising:
maintaining a context for the UE in a memory, when the UE transitions from a connected state associated with a protocol for controlling radio resources to an inactive or idle state associated with the protocol,
wherein the determining includes using the context.

3. The method of claim 2, further comprising:
receiving, at the DU from the UE, a logical channel identifier (LCID); and
determining the identifier using the context and the LCID.

4. The method of claim 1, further comprising:
discarding a context for the UE when the UE transitions from a connected state associated with the protocol to an inactive or idle state associated with the protocol; and
performing a context setup procedure with the CU to generate at least one tunnel endpoint identifier (TEID).

5. The method of claim 1, wherein communicating the data includes:
receiving, from the UE, a plurality of uplink data segments in respective medium access control packet data units (MAC PDUs), subsequently to receiving the uplink message; and
transmitting a single data packet comprising the plurality of uplink data segments to the central unit user plane (CU-UP) or the central unit control plane (CU-CP).

6. The method of claim 1, wherein communicating the data includes:
receiving, from the UE, a plurality of uplink data packets in respective medium access control packet data units (MAC PDUs), subsequently to receiving the uplink message; and
transmitting the plurality of uplink data packets to the central unit user plane (CU-UP) or the central unit control plane (CU-CP).

7. The method of claim 1, wherein:
the receiving includes receiving an uplink data packet and a logical channel identifier (LCID) associated with the uplink data packet; and
the communicating includes:
in a first instance, in response to determining that a tunnel corresponding to the LCID exists, transmitting the uplink data packet to the CU via the tunnel, and
in a second instance, in response to determining that no tunnel corresponding to the LCID exists, either (i) transmitting the uplink data packet and the LCID to the CU in a DU-to-CU message or (ii) establishing a new tunnel and transmitting the uplink data to the CU via the new tunnel.

8. A method, in a central unit (CU) of a distributed base station, for managing early data transmission (EDT) from a user equipment (UE), the method comprising:
receiving, at the UE from a distributed unit (DU), a message from a UE;
determining, based on the message, that the UE is performing EDT;
establishing at least one tunnel for communicating data between the UE and a core network via the DU and the CU; and
transmitting, from the CU, a data packet to the DU using the at least one tunnel.

9. The method of claim 8, further comprising:
performing a bearer context modification procedure with the DU, to resume a use of the context for the UE.

10. The method of claim 8, further comprising:
performing a context setup procedure with the DU to generate a context for the UE and obtain at least one tunnel endpoint identifier (TEID) for the at least one tunnel.

11. The method of claim 10, further comprising:
receiving, from the DU, a temporary identifier for the UE;
resolving the temporary identifier to identify a second base station that provided a most-recent prior serving cell to the UE; and
retrieving the context for the UE from the second base station.

12. The method of claim 8, wherein communicating the data includes:
receiving, from the DU, a plurality of uplink data packets.

13. The method of claim 8, wherein transmitting the data packet to the DU using the at least one tunnel includes:
transmitting, from the central unit user plane (CU-UP) to the central unit control plane (CU-CP), the data packet; and
transmitting, from the CU-CP to the DU, the data along with a radio resource control (RRC) command in a CU-to-DU message.

14. (canceled)

15. An apparatus, operating as a distributed unit (DU) of a distributed base station and configured to manage an early data transmission (EDT) from a user equipment (UE), the apparatus comprising:
processing hardware configured to:
receive, at the DU, an uplink message from the UE, when a radio connection between the UE and the DU is not active;
determine, based on the uplink message, an identifier for communicating data related to the UE between the DU and a central unit (CU) of the distributed base station; and
communicate, at the DU with the CU, the data using the identifier.

16. The apparatus of claim 15, wherein the processing hardware is further configured to:
maintain a context for the UE in a memory, when the UE transitions from a connected state associated with a protocol for controlling radio resources to an inactive or idle state associated with the protocol;
wherein the processing hardware configured to determine the identifier includes processing hardware configured to determine the identifier using the context.

17. The apparatus of claim 16, wherein the processing hardware is further configured to:
receive, at the DU from the UE, a logical channel identifier (LCID); and
determine the identifier using the context and the LCID.

18. The apparatus of claim 15, wherein the processing hardware is further configured to:
discard a context for the UE when the UE transitions from a connected state associated with the protocol to an inactive or idle state associated with the protocol; and
perform a context setup procedure with the CU to generate at least one tunnel endpoint identifier (TEID).

19. The apparatus of claim 15, wherein the processing hardware configured to communicate the data includes processing hardware configured to:
receive, from the UE, a plurality of uplink data segments in respective medium access control packet data units (MAC PDUs), subsequently to receiving the uplink message; and
transmit a single data packet comprising the plurality of uplink data segments to the central unit user plane (CU-UP) or the central unit control plane (CU-CP).

20. The apparatus of claim 15, wherein the processing hardware configured to communicate the data includes processing hardware configured to:
receive, from the UE, a plurality of uplink data packets in respective MAC PDUs, subsequently to receiving the uplink message; and
transmit the plurality of uplink data packets to the central unit user plane (CU-UP) or the central unit control plane (CU-CP).

21. The apparatus of claim 15, wherein:
the processing hardware configured to receive includes processing hardware configured to receive an uplink data packet and a logical channel identifier (LCID) associated with the uplink data packet; and
the processing hardware configured to communicate includes processing hardware configured to:
in a first instance, in response to a determination that a tunnel corresponding to the LCID exists, transmit the uplink data packet to the CU via the tunnel, and
in a second instance, in response to a determination that no tunnel corresponding to the LCID exists, either (i) transmit the uplink data packet and the LCID to the CU in a DU-to-CU message or (ii) establish a new tunnel and transmitting the uplink data to the CU via the new tunnel.
